(19) United States
(12) Patent Application Publication
(10) Pub. No.: US 2023/0069764 A1
(43) Pub. Date: Mar. 2, 2023

(54) SYSTEMS AND METHODS FOR USING NATURAL GAZE DYNAMICS TO DETECT INPUT RECOGNITION ERRORS

(71) Applicant: Meta Platforms Technologies, LLC, Menlo Park, CA (US)

(72) Inventors: Tanya Renee Jonker, Seattle, WA (US); Candace Peacock, Boulder, CO (US); Benjamin Lafreniere, Toronto (CA); Ting Zhang, Lake Jackson, TX (US); Hrvoje Benko, Seattle, WA (US); Rawan Alghofaili, Fairfax, VA (US); Michael Glueck, Toronto (CA)

(21) Appl. No.: 17/866,179

(22) Filed: Jul. 15, 2022

Related U.S. Application Data
(60) Provisional application No. 63/236,657, filed on Aug. 24, 2021.

(51) Int. Cl. G06F 3/01; G06F 9/451

(52) U.S. Cl. CPC G06F 3/013; G06F 9/451

(57) ABSTRACT

A disclosed computer-implemented method may include (1) tracking a gaze of a user as the user interacts with a user interface, (2) determining, based on tracking of the gaze of the user, that a detected user interaction with the user interface represents a false positive input inference by the user interface, and (3) executing at least one remedial action based on determining that the detected user interaction represents the false positive input inference by the user interface. Various other methods, systems, and computer-readable media are also disclosed.

### CROSS REFERENCE TO RELATED APPLICATION

This application claims the benefit of U.S. Provisional Pat. Application 63/236,657, filed Aug. 24, 2021, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 shows an interface view of a study task interface in accordance with some examples provided herein.

FIG. 2 shows example timelines for tile interaction around user clicks for true positives (e.g., intentional selections of a target) and false positives (e.g., injected selections on non-target items).

FIG. 3A through FIG. 3C show a set of plots that visualize a variety of time series of gaze data following true positive (TP) and false positive (FP) selections and may indicate whether there was a significant difference at each time point as per paired t-tests (as described above).

FIG. 4A through FIG. 4D show a set of plots that may include area-under-thecurve (AUC) of the Receiver Operator Characteristic (ROC) (also “AUC-ROC” herein) scores from an individual model described herein.

FIG. 5A through FIG. 5D show a set of plots that may include AUC-ROC scores from a group model described herein.

FIG. 6A through FIG. 6C show a set of plots that may include a number of time series of gaze features from the matched participants in an original study and a replication study described herein.

FIG. 7 shows a plot that shows the individual model results and the group model results as described herein.

FIG. 8A through FIG. 8C show a set of plots of individual model averaged learning curves in accordance with an embodiment described herein.

FIG. 9A through FIG. 9C show a set of plots of group model learning curves in accordance with an embodiment described herein.

FIG. 10 shows a visualization of Ul changes following serial true positives and end true positives.

FIG. 11A through FIG. 11C show a set of plots that visualize the time series of the serial true positives and end true positives for each feature.

FIG. 12A through FIG. 12D include a set of plots of AUC-ROC scores when the group model is tested on serial true positives and end true positives.

FIG. 13A through FIG. 13D show a set of plots of AUC-ROC scores for the matched original and replication study participants.

FIG. 14 is a block diagram of an example system for using natural gaze dynamics to detect input recognition errors in accordance with at least one embodiment described herein.

FIG. 15 is a block diagram of an example implementation of a system for using natural gaze dynamics to detect input recognition errors in accordance with at least one embodiment described herein.

FIG. 16 is a flow diagram of an example method for using natural gaze dynamics to detect input recognition errors according to at least one embodiment described herein.

FIG. 17 is a flow diagram of example remedial actions and/or effects on a user experience of some examples described herein.

FIG. 18 is an illustration of example augmented-reality glasses that may be used in connection with embodiments of this disclosure.

FIG. 19 is an illustration of an example virtual-reality headset that may be used in connection with embodiments of this disclosure.

FIG. 20 is an illustration of an example system that incorporates an eye-tracking subsystem capable of tracking a user’s eye(s).

FIG. 21 is a more detailed illustration of various aspects of the eye-tracking subsystem illustrated in FIG. 20.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

Recognition-based input techniques are growing in popularity for augmented and virtual reality applications. These techniques must distinguish intentional input actions (e.g., the user performing a free-hand selection gesture) from all other user behaviors. When this recognition fails, two kinds of system errors can occur: false positives, where the system recognizes an input action when the user did not intentionally perform one, and false negatives, where the system fails to recognize an input action that was intentionally performed by the user.

If an input system were able to detect when it has made these errors, it could use this information to refine its recognition model to make fewer errors in the future. Additionally, the system could assist with error recovery if it could detect the errors soon enough after they occur. This capability would be particularly compelling for false positive errors. These false positive errors may be damaging to the user experience in part due to the attentional demands/costs to the user to detect and fix them when they occur. For example, if the system were to rapidly detect a false positive, it could increase the physical salience and size of an undo button or provide an “undo” confirmation dialogue.

The present disclosure is directed to systems and methods for using natural gaze dynamics to detect input recognition errors. Gaze may be a compelling modality for this purpose because it may provide indications of fast, real-time changes in cognitive state, it may be tightly linked with behavior and gestures, and it may be sensitive to environmental inconsistencies.

The present disclosure may focus on false positive errors because these have been shown to be particularly costly to users. Furthermore, there may be a number of emerging techniques that may aim to assist with false negative errors, such as bi-level thresholding, which may implicitly detect false negative errors through scores that are close to the recognizer threshold, and then adjusts the threshold to allow users to succeed when trying the gesture a second time. The systems and methods of the present disclosure may be distinct in that they may focus on detecting false positive errors. The systems and methods may also relate to the use of gaze to detect recognizer errors, as bi-level thresholding only focuses on the signal that the gesture recognizer uses.

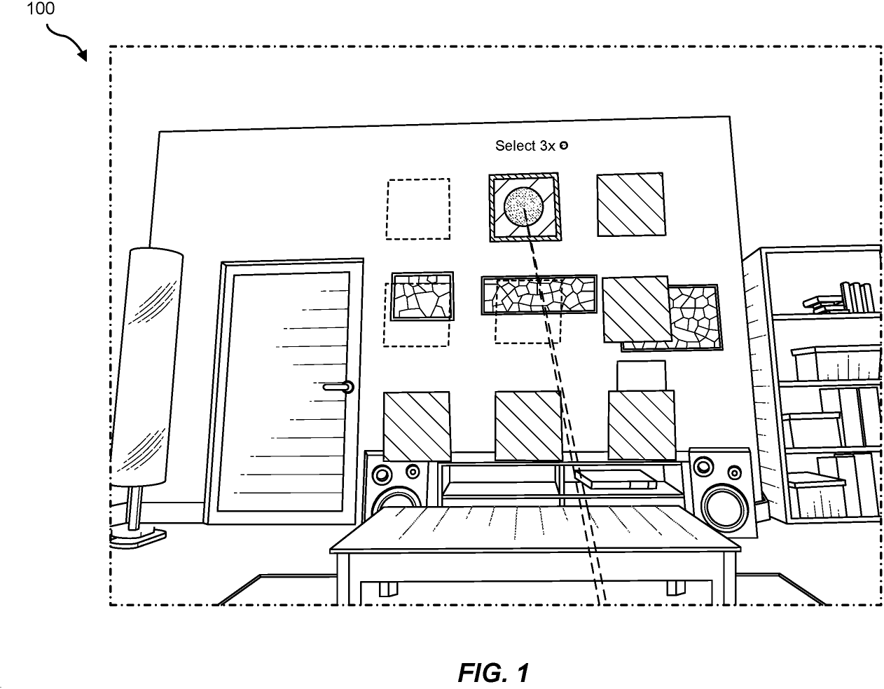

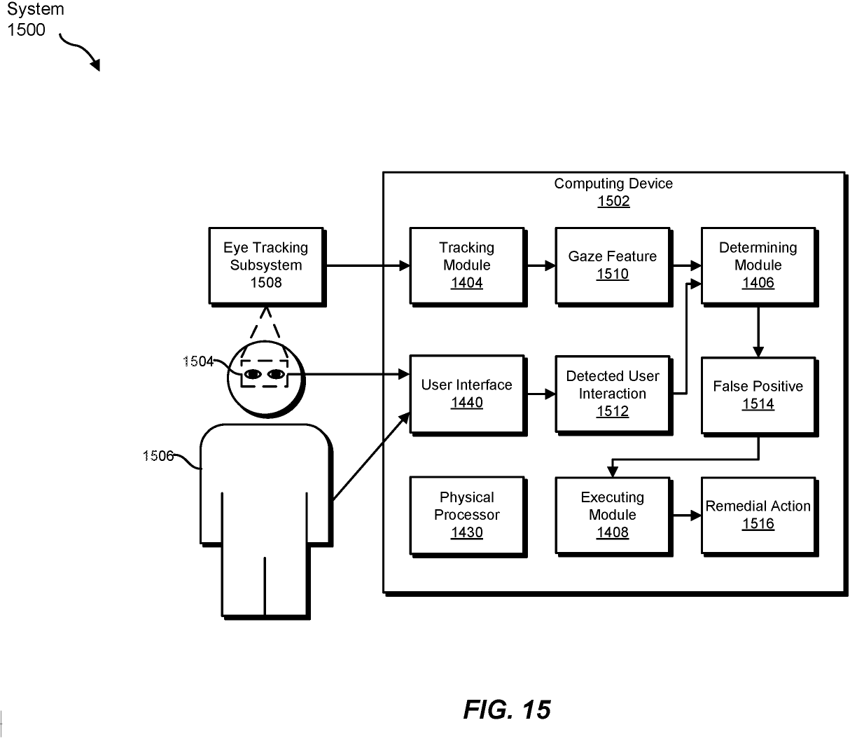

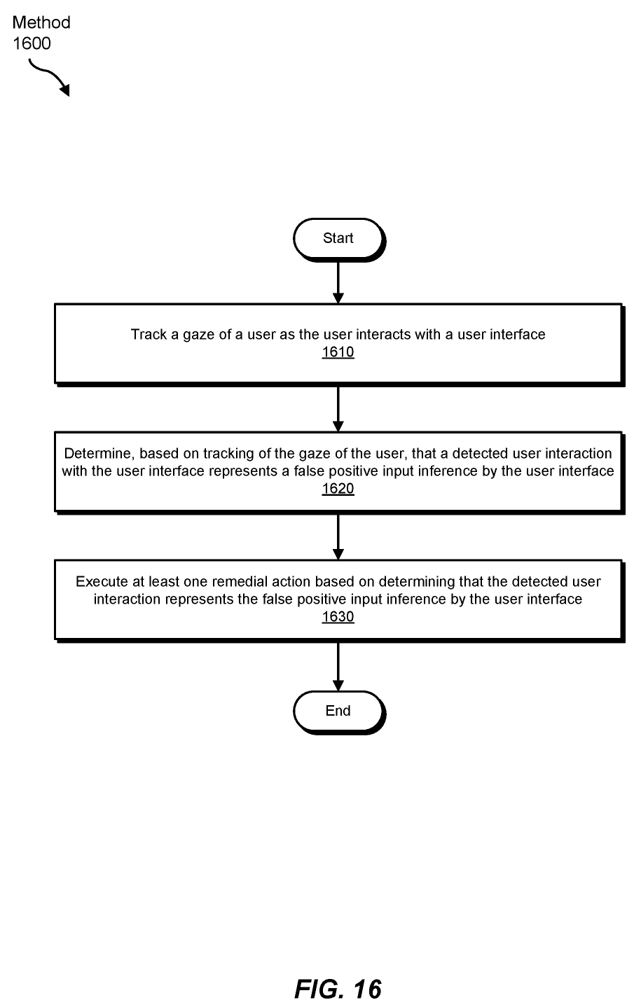

The following will provide, with reference to FIGS. 1-14, descriptions and explanations of studies and experimental work undertaken by the inventors in relation to the systems and methods described herein. The following will also provide, with reference to FIGS. 15 and 17-21, detailed descriptions of systems for using natural gaze dynamics to detect input recognition errors. Detailed descriptions of corresponding computer-implemented methods will also be provided in connection with FIG. 16.

To provide a demonstration that gaze is sensitive to system errors, an experimental task was developed to mimic a common serial selection task in which users searched through tiles to locate hidden targets. As users searched through the tiles, the system would occasionally inject ‘click’ actions to select an item on the user’s behalf (i.e., false positive errors). By examining gaze behavior following true positives (i.e., user-initiated selections) versus false positives (i.e., injected selections) the inventors tested a hypothesis that gaze may be used to distinguish false positive selections.

The results revealed several novel findings on gaze as may relate to false positive input errors. For example, gaze features varied consistently following true selection events versus system-generated input errors. Additionally, a simple machine learning model was able to discriminate true selections from false selections, receiving a score of 0.81 using the areaunder-the-curve (AUC) of the Receiver Operator Characteristic (ROC). This may demonstrate the utility of gaze for error detection. Moreover, the model detected errors almost immediately (at 50 ms, 0.63 AUC-ROC) and decoding performance increased as time continued (at 550 ms, 0.81 AUC-ROC). Finally, model performance peaked between 300 ms and 550 ms which suggests that systems might be able to use gaze dynamics to detect errors and provide low-friction error mediation.

Together, these findings may have implications for the design of models that detect when a system has incorrectly inferred user input so that systems can adaptively fix these errors and reduce friction that may impact a user experience. Furthermore, given that gaze can detect errors rapidly after they occur, this may open a new space of research questions around how a system could use this capability to help users recover from errors, and generally improve user experience.

Thirty-two participants (mean age = 35, 13 females, 30 right-handed) provided informed consent under a protocol approved by the Western Institutional Review Board. Participants were screened to have normal or corrected-to-normal vision with contact lenses (glasses were disallowed as they interfere with successful eye tracking). Participants received equipment by mail and interfaced with researchers through video calls to complete the experiment remotely. Three participants were removed from the final analysis, resulting in a final sample size of 29 participants; one participant was removed because they did not pass data validation (see below) and, due to a bug in the code, two participants received no false positive errors.

Eye and head movements were collected from a head-mounted display (HMD). Eye-tracking data was logged at 60 Hz for all participants. Prior to the experiment, each participant completed a 9-point calibration procedure. To ensure successful calibration within the task environment, participants were to maintain fixation on the central tile for 60 s during the task tutorial. If participants maintained fixation on the central tile for at least 75% of the 60 s period and gaze velocity was below 30 °/s, then participants were allowed to complete the rest of the study. If these criteria were not met, the calibration and validation procedures were repeated.

FIG. 1 shows an interface view 100 of a study task interface. The study task involved uncovering and selecting target items using a ray-cast pointer. The pointer was enabled whenever participants rested their thumb on a touchpad of the HMD controller. On each “page”, six randomly selected tiles in a 3 x 3 grid were enabled. The user was instructed to search for a specified number of a target item (e.g., “Select 2 x green circles”). To reveal the contents of an enabled tile, the user was required to dwell on the tile for 1.25 seconds. During the dwell period, a radial progress indicator progressively filled. Once the dwell time was completed, the tile flipped to reveal one of six icons (e.g., a green circle, a red heart, an orange triangle, a yellow star, a blue moon, or a purple plus). If the icon matched the target (a green circle, continuing with the above example), the user was directed to select the tile by briefly breaking and then reengaging contact between the user’s thumb and the controller’s touchpad. If the tile was not selected within 1.0 seconds, the tile closed automatically. If selected, the tile would close 0.5 seconds following the click.

To provide feedback on selection, the tile would be given a blue border, the ray-cast pointer would change to yellow, and a click sound would occur. To prevent rapid clicking, a 1.0 second lockout was imposed following a click. During this time, the ray-cast pointer would temporarily change to grey to communicate the lockout state. Once the specified number of target items were selected, the system proceeded to the next page.

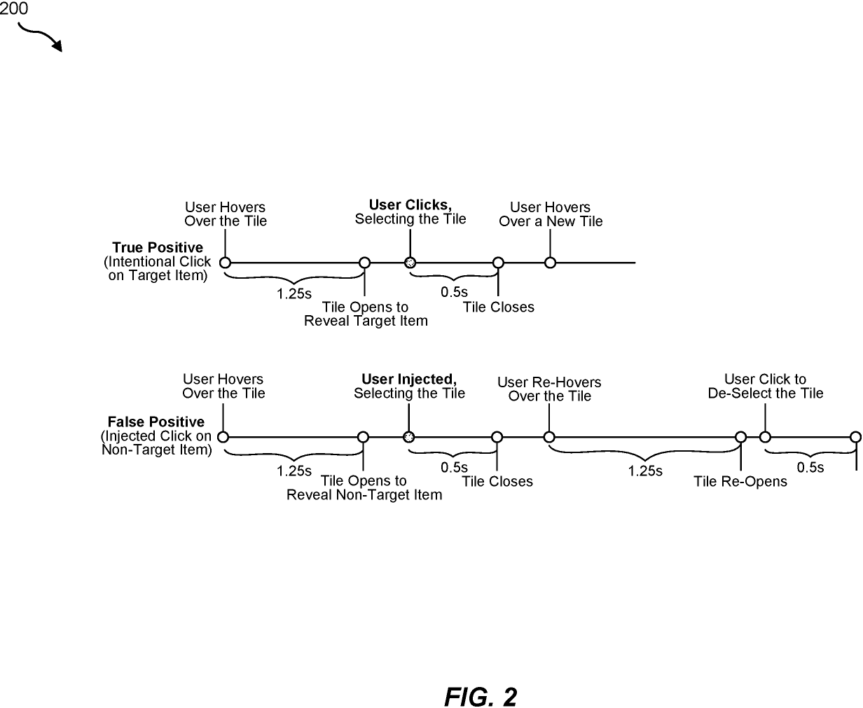

FIG. 2 shows a set of timelines 200 that indicate timelines for tile interaction around user clicks for true positives (e.g., intentional selections of a target) and false positives (e.g., injected selections on non-target items). As shown in FIG. 2, during the experiment, the system occasionally injected false positive errors when a user uncovered a non-target icon. A click was injected at a randomly selected time between 0.2 seconds and 0.5 seconds after the tile was opened or at the moment when the user’s ray-cast pointer left the tile, whichever occurred first. When the system injected an error, the non-target item would appear selected, and the click feedback would occur. To de-select the erroneously selected item, the user was required to first re-open the tile and then click to de-select it. To create a consistent penalty to errors, the system prevented the user from opening any other tiles until the error was corrected.

Visual feedback following true positives and false positives was designed to be identical in the 500 ms following the click occurrence to ensure that there were no systematic differences in user interface visuals that would affect eye movements.

Each participant experienced 12 “blocks” of the task described above, each consisting of 60 tile openings over a number of trials. Across all tile openings in a block, ^{~}50% revealed target items, and the rest revealed a randomly selected non-target item; a total of 9 false positives were injected (9/60 trials, or 15% of the time). Before the start of each block, the icon to be used as the target item was communicated to the participant (e.g., “The target item for this block is the circle”). The order of the different target items was counterbalanced across participants using a balanced Latin square.

At the beginning of the experiment, there were two practice blocks. Participants practiced selected target icons in the first practice block and practiced deselecting icons when errors were injected in the second block.

The first step of pre-processing the gaze data involved transforming the 3D gaze vectors from the eye-in-head frame of reference to an eye-in-world direction using head orientation. Next, the inventors computed angular displacement between consecutive gaze samples, represented as normalized vectors u and ν, θ = 2 · arctan2(II u - ν II, II u + ν II). Gaze velocity was computed as θ divided by the change in time between gaze samples.

Gaze data were then filtered to remove noise and unwanted segments before event detection and feature extraction. Data from the practice trials and breaks was discarded prior to analysis, and we remove all gaze samples where gaze velocity exceeds 800 degrees per second, indicating unfeasibly fast eye movements. All missing values were then replaced through interpolation. Finally, a median filter with a width of seven samples was applied to the gaze velocity signal to smooth the signal and account for noise prior to event detection.

l-VT saccade detection was performed on the filtered gaze velocity by identifying consecutive samples that exceeded 700 degrees per second. A minimum duration of 17 ms and maximum duration of 200 ms was enforced for saccades. I-DT fixation detection was performed by computing dispersion over time windows as the largest angular displacement from the centroid of gaze samples. Time windows where dispersion did not exceed 1 degree were marked as fixations. A minimum duration of 50 ms and maximum duration of 1.5 s was enforced for fixations.

The inventors explored at least 10 total features including, without limitation, fixation duration, the angular displacement between fixation centroids, the angular displacement between the current and previous saccade centroids, the angular displacement between the current and previous saccade landing points, saccade amplitude, saccade duration, fixation probability, saccade probability, gaze velocity, and dispersion.

In some examples, both fixation durations and the distance between fixations and targets may be affected by incongruent scene information. Therefore, the inventors opted to look at fixation durations and the angular displacement between the current and previous fixation centroid. Along the same vein, the angular displacement between fixation centroids may be related to how far the eyes move from fixation to fixation (i.e., saccades). The inventors therefore also looked at several saccade features: the angular displacement between the current and previous saccade centroid, the angular displacement between the current and previous saccade landing points, saccade amplitude, and saccade duration. Finally, because errors are likely to influence how much users move their eyes and the probability that users move their eyes (e.g., users might move their eyes less following error injections), the inventors also used several continuous features that provided measures of visual exploration: fixation probability, saccade probability, gaze velocity, and dispersion. The dispersion algorithm requires a time parameter that indicates the amount of gaze data to be included in the computation. In some examples, this time parameter may be set to 1000 ms.

To represent these features as a continuous time-series, the inventors linearly interpolated empty values between each saccade and fixation feature. Each feature was then z-scored within-participant.

To determine whether gaze features differed following true selections versus false positives as a function of each time point, the inventors conducted a statistical analysis over the time series. To do so, the inventors computed the average value for each feature and each time point for each participant. the inventors then statistically compared each time point via a paired t-test to determine which points in time are statistically different for each feature. All 36 time points starting from 17 ms to 600 ms following selections were used. This resulted in 36 paired t-tests conducted for each feature. The false detection rate (FDR) correction was used to control for multiple comparisons across the lens sizes for each feature.

To determine whether gaze features could be used to classify true selections versus false positives, the inventors trained and tested a set of logistic regression models. Importantly, to explore how quickly a system might detect a false positive error, the inventors trained models with varying time durations following the selection event, which the inventors refer to as the lens approach. Here, the inventors used gaze data following the selection event (true and false) from 50 ms to 600 ms in 50 ms bins (e.g., a total of 12 lens sizes). The inventors set 600 ms as the maximum time used since this was the average amount of time it took to select a new tile following a true selection. Furthermore, the inventors only used true selections that were followed by another selection and eliminated true selections that occurred at the end of a trial since true selections at the end of the trial were followed by unique graphical visualizations (i.e., shuffling of tiles) rather than the standard selection feedback, which might elicit different gaze behaviors.

Here, each sample was an eventual beta parameter. For the 50 ms lens size, there were 3 beta parameters for each feature since there were 3 samples that occurred in the 50 ms following error injection. Weights were set to inverse class balance.

Model performance for prediction was measured using the area-under-thecurve (AUC) of the Receiver Operator Characteristic (ROC). The ROC curve is constructed to model true positive rate as a function of false positives at different threshold values. Larger values indicate better predictive performance of the model, and all results are compared to a baseline value of 0.5 that represents a no skill classifier that performs classification by guessing.

The first set of models were trained and tested for each individual, which allowed the models to represent individual differences in gaze features. Individual models were trained on 80% of data and tested on 20% of held out data.

Group models were used to determine whether gaze behaviors that differentiate true selections from false positives are in fact consistent across people. Group models were trained on a leave one participant out cross-validation. Here, models were trained on N-1 datasets and tested on the left-out dataset.

Any comparison of the AUC-ROC value at lens size was compared to chance (0.5) using a one-sample t-test. Any comparisons of two AUC-ROC values for a given lens size were conducted using paired t-tests. The false detection rate (FDR) correction was used to control for multiple comparisons across the lens sizes for each feature.

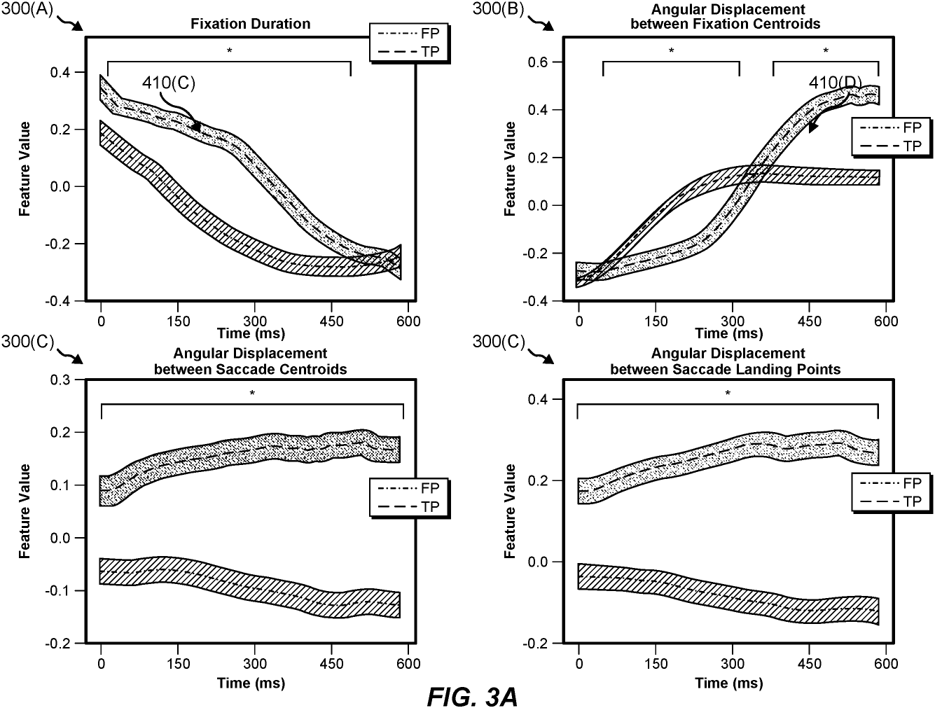

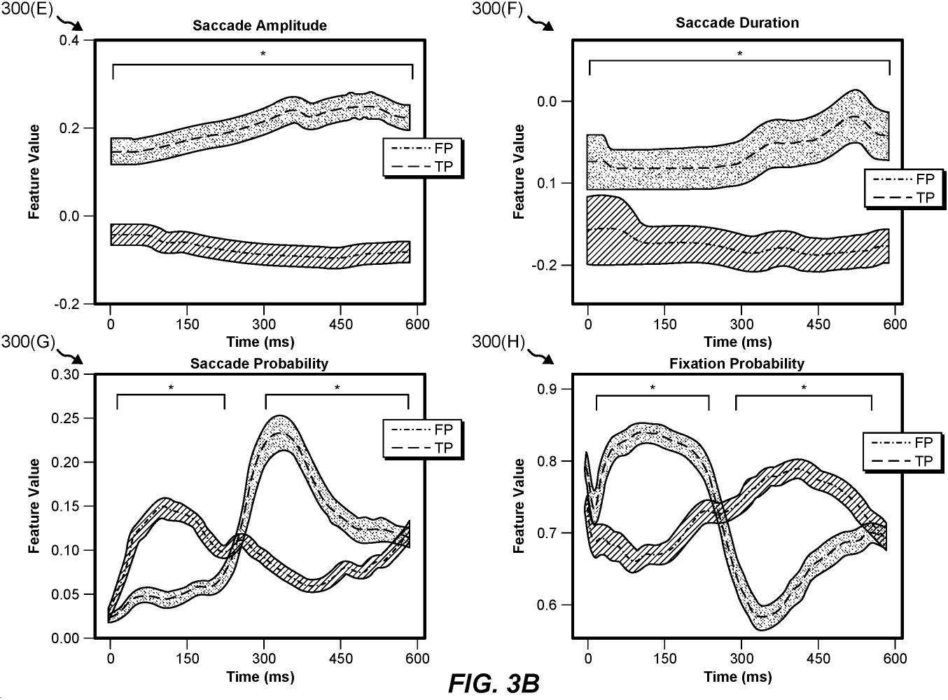

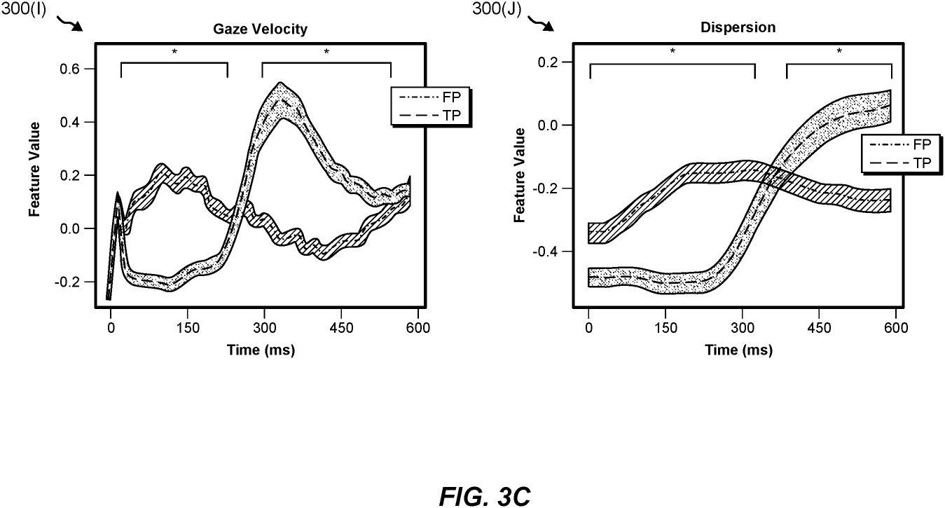

In one example, the foregoing showed that gaze features may differ following true positive and false positive selections. The inventors’ first hypothesis tested whether gaze features differ following true positive and false positive selections and how this relates to time. FIGS. 3A through 3C show a set of plots 300 (e.g., plot 300(A) through plot 300(J)) that visualize a variety of time series of gaze data following true positive (TP) and false positive (FP) selections and may indicate whether there was a significant difference at each time point as per paired t-tests (as described above).

The plots included in FIGS. 3A through 3C visualize the time series of the fixation features, saccade features, and continuous features following the true positive (dashed line) and false positive (dashed and dotted line) selections. Brackets correspond to the points in the time series that were significantly different from each other per paired t-tests. Error bands correspond to one standard error of the mean.

Overall, as shown in FIGS. 3A through 3C, there were significant differences across all features. In summary, these results reflect a pattern of behavior in which people moved their eyes more immediately following false positive selections, as they were not aware that an error was injected and later moved their eyes less once they were cognizant that an error occurred. Conversely, people moved their eyes less immediately following true selections, as they paid attention to ensure the system correctly registered the selection and later moved their eyes more as they explored which tile to select next. Together, these data support our hypothesis that there are patterns of gaze that differ following true positive and false positive selections.

The foregoing may also show that individual user models may discriminate true selections from false positives using gaze dynamics alone. By exploring individual models first, the inventors ensured that the models could account for potential individual differences in gaze features across users. The inventors tested whether individual models could detect errors above chance when considering each individual gaze feature and when considering all gaze features simultaneously.

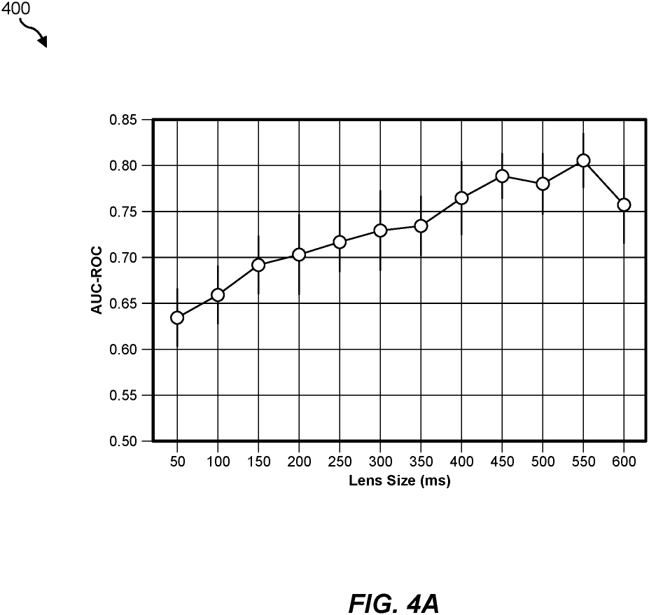

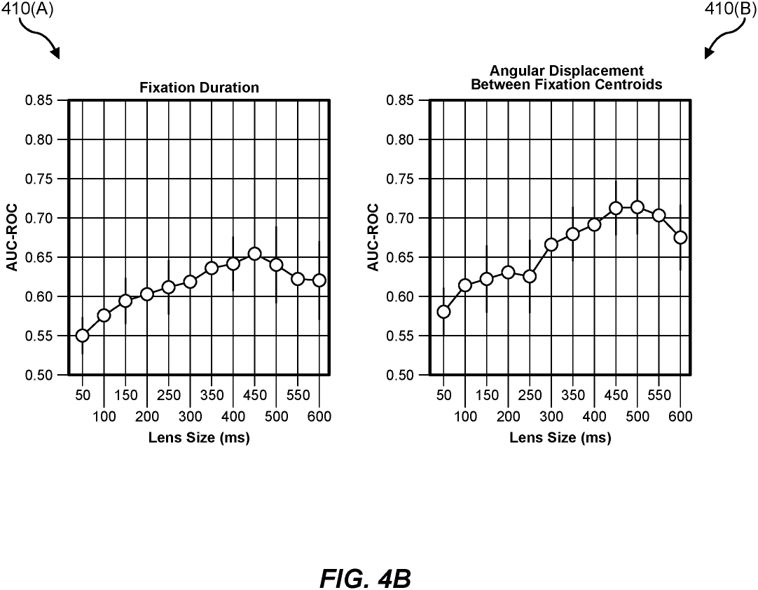

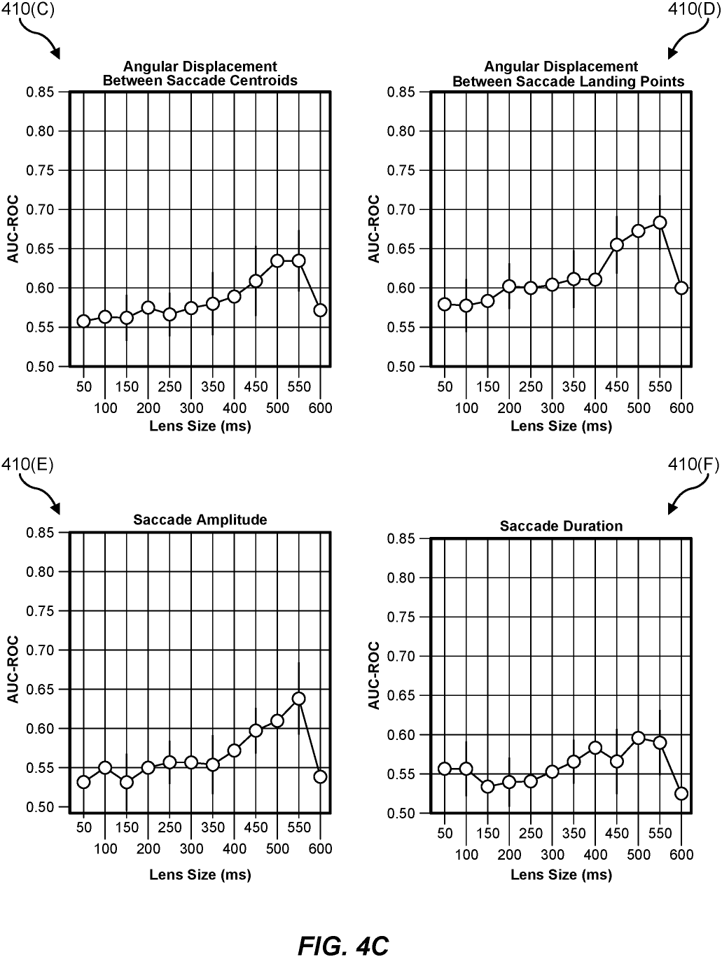

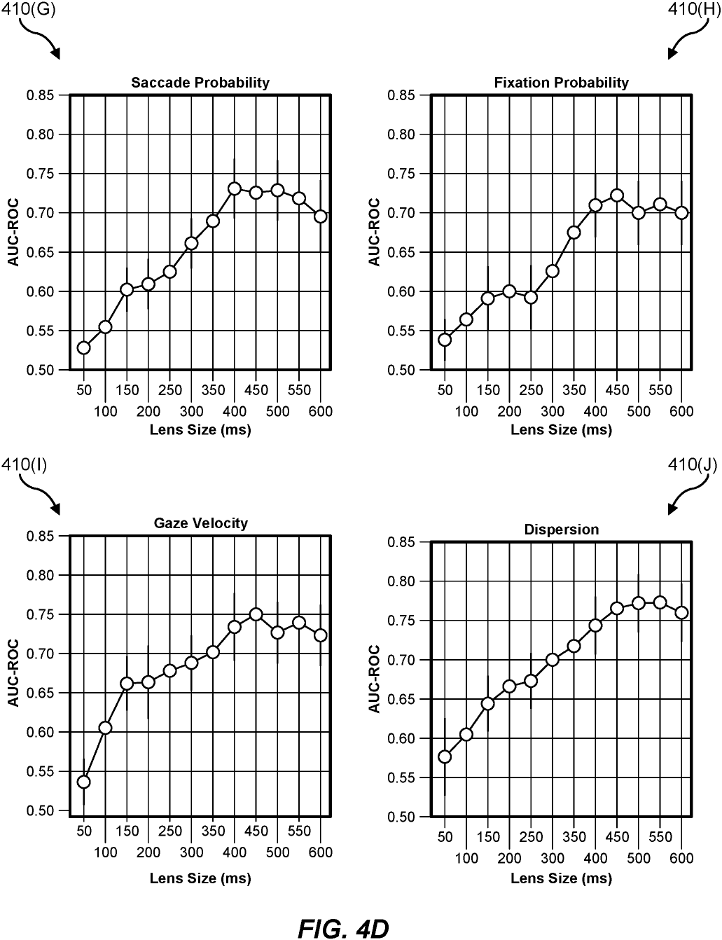

One sample t-tests indicated that the individual models could discriminate true selections from false positives well above chance for all lens sizes for each feature (false discovery rate corrected p-values (FDR ps) < 0.05) with three exceptions: the inventors found no statistical significance for saccade amplitudes at 600 ms and saccade durations at 150 and 600 ms (FIG. 4; FDR ps > 0.05). This suggests that each feature was relatively sensitive to error injection for each participant and that these effects were not due to a single feature.

Next, the inventors tested whether individual models trained on all features could discriminate true selections from false positives. This was indeed the case: one-sample t-tests revealed that the individual model with all features performed significantly better than chance for all lens sizes (all FDR ps < 0.05).

FIGS. 4A through 4C show a set of plots that may include AUC-ROC scores from the individual model. Plot 400 in FIG. 4A shows the AUC-ROC values for each lens size when considering all features at each lens size in the individual model. Plots 410 (e.g., plot 410(A) through plot 410(J) in FIG. 4B through FIG. 4D) show the AUC-ROC values for the individual features at each lens size. Error bars refer to confidence intervals.

Together, these findings support a hypothesis that individual models trained on gaze features can discriminate between true selections and false positive errors within milliseconds of the event. Furthermore, it did not appear that a particular feature was driving the classification accuracy, as all the features were sensitive to true and false selections.

Additionally, the experimental results support a hypothesis that there are general gaze features that can discriminate between true selections and false positives across many participants. If a group model is effective even on a held-out participant, it may indicate that there are general patterns of gaze and that the general model can be useful even for entirely new users. If this is the case, then it is likely that a group model of gaze could be used as a cold start model in a system that is not yet personalized. As with the individual models, the inventors tested whether group models could detect errors above chance when considering individual features and when considering all gaze features.

When considering each individual feature, all lens sizes for each feature were significantly greater than chance via a one-sample t-test (all FDR ps < 0.05). The same held true when considering a group model with all features and all lens sizes (Table 3; all FDR ps < 0.05). Overall, these findings demonstrated that group models of individual features were able to detect when false positive errors were injected for held-out participants and that this effect was not driven by any specific features. Together, these results support a hypothesis that a group model trained on gaze features can detect errors for users the model has not seen. This suggests that the group model would be a suitable cold start model in systems that are not yet personalized.

Furthermore, as discussed in greater detail below, learning curves may suggest that the individual models would likely perform better than the group model if the individual models contained more training data. Moreover, the performance of the group model largely does not change when there are changes to the Ul and task following true selections.

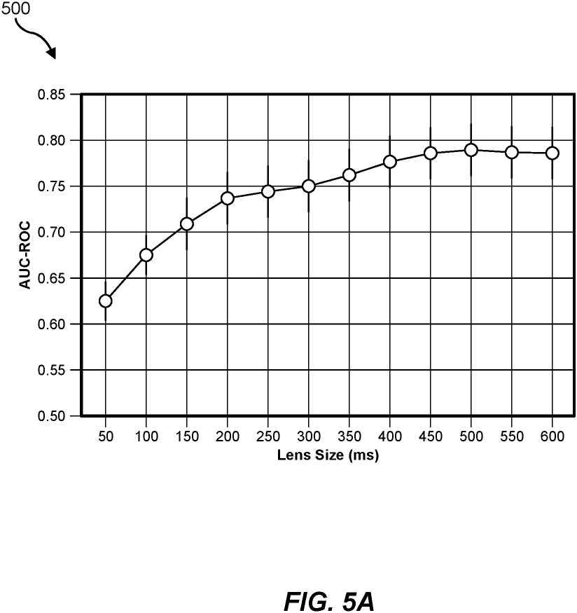

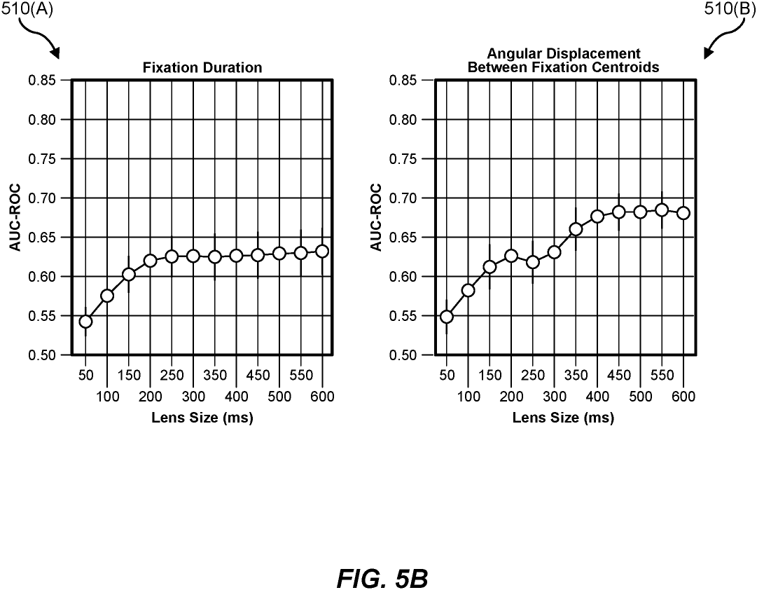

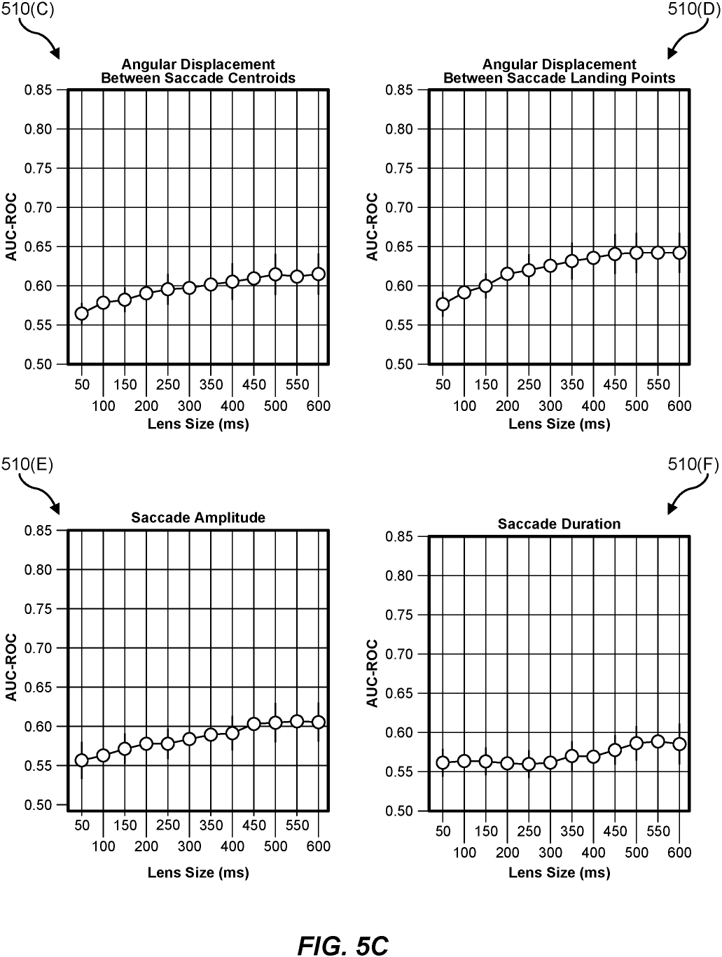

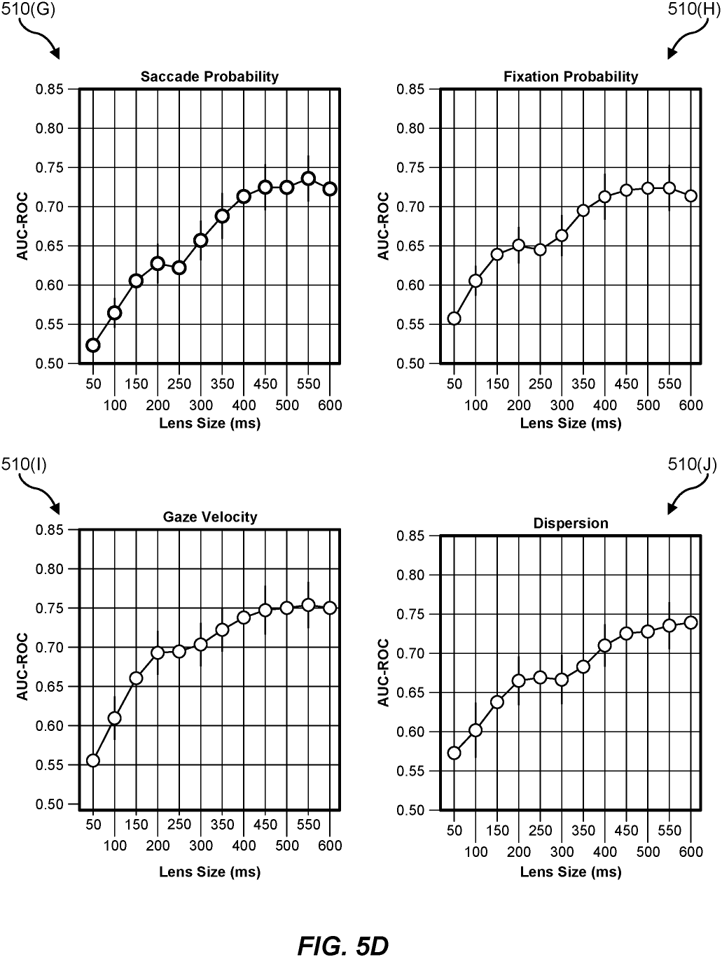

FIGS. 5A through 5D show a set of plots that may include AUC-ROC scores from the group model. Plot 500 in FIG. 5A shows the AUC-ROC values for each lens size when considering all features at each lens size in the group model. Plots 510 (e.g., plot 510(A) through plot 510(J) in FIG. 5B through FIG. 5D) show the AUC-ROC values for the individual features at each lens size. Error bars refer to confidence intervals.

One potential confound in the initial experiment may have been the method in which errors were injected. Specifically, errors were injected randomly within 200 and 500 ms of tile opening, or when the participant’s cursor left the bounds of the tile. This latter criterion could perhaps introduce a confound because the false positive errors were more likely to occur during hand motion, which the inventors know to correlate with gaze motion. To address this potential concern, the inventors reran the experiment without this contingency; instead, the inventors randomly injected false positives based upon time alone (200 to 500 ms after a tile opened).

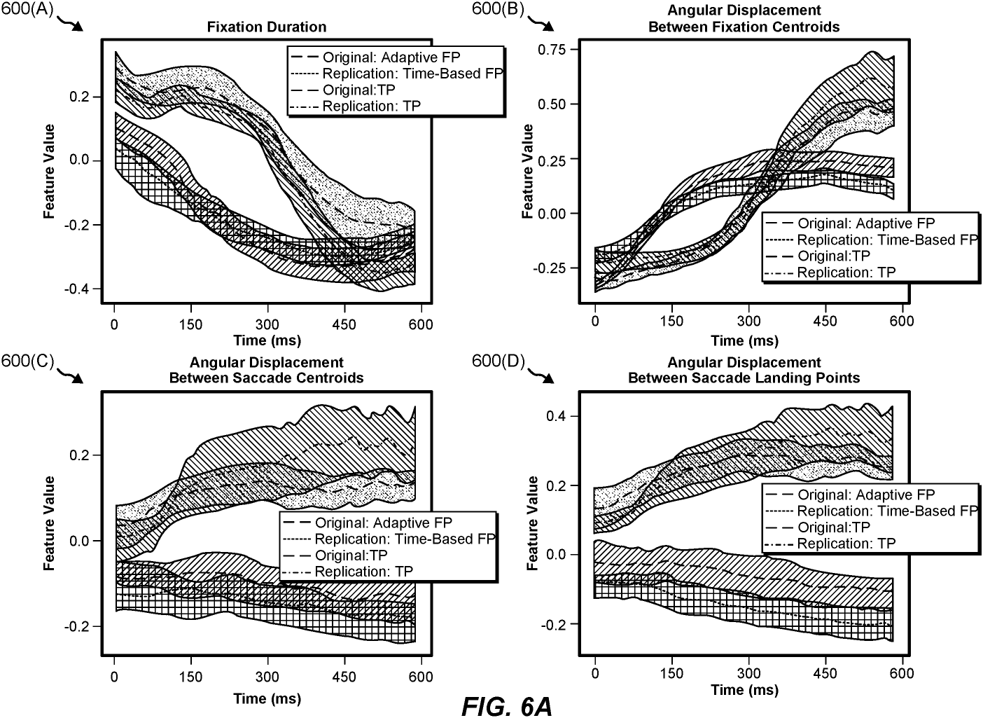

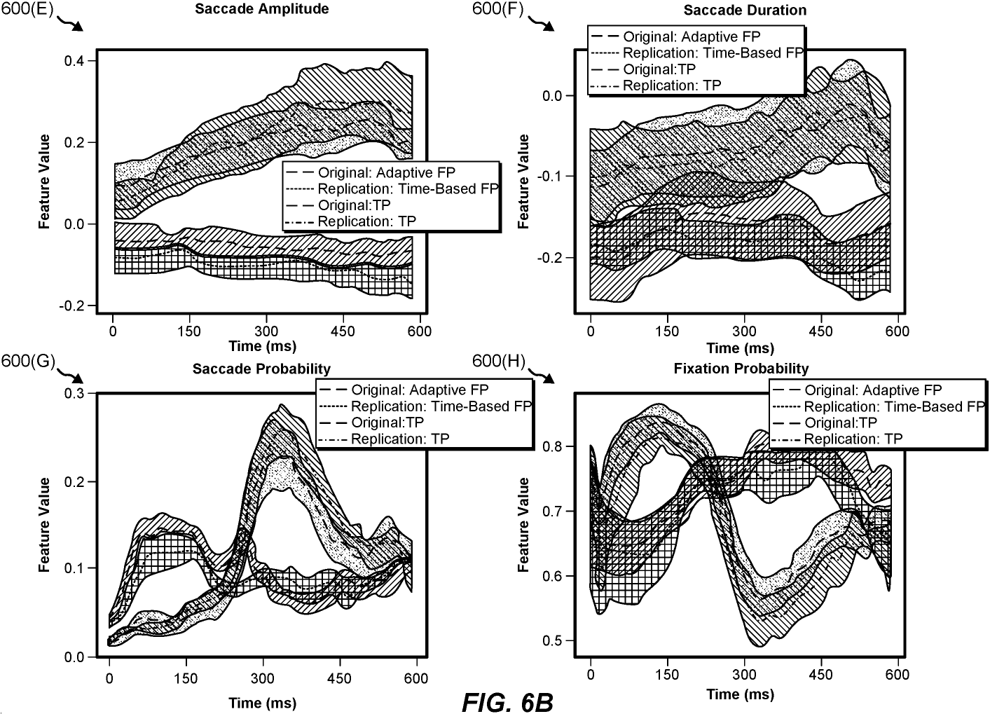

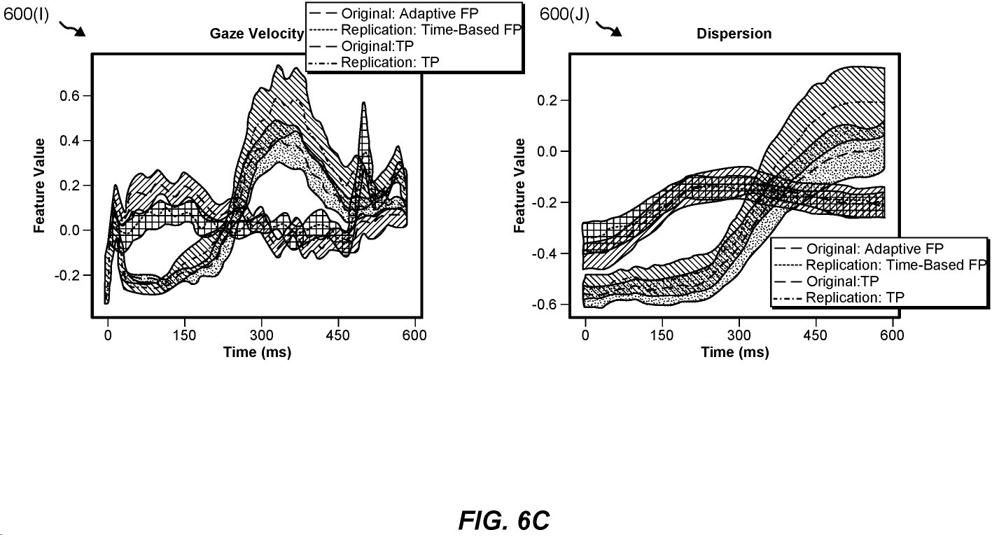

The inventors administered the revised experiment to 10 of the original participants (mean age = 35, 5 females, 10 right-handed). By using a subset of the original study participants, the inventors were able to directly test whether behaviors changed as a function of how errors were injected. If behaviors changed as a function of adaptive versus time-based injection, this would suggest that the original results were simply an artifact of the task setup. However, if behaviors are stable irrespective of how errors were injected, then this suggests the original results captured general behaviors in response to errors. FIG. 6 shows the time series of gaze features following true positives and error injections in Experiments 1 and 2. Overall, this visualization shows that the time series are similar across studies despite changing the mechanism by which errors were injected. Furthermore, the results did not change when the inventors reran the modeling analyses.

FIGS. 6A through 6C show a set of plots 600 (e.g., plot 600(A) through plot 600(J)) that may include a plurality of time series of gaze features from the matched participants in the original and replication studies. The plot visualizes the time series of the fixation features, saccade features, and continuous features from the matched participants from the original and replication studies. The time series corresponding to true positive selections are visualized from the original study (dashed line with speckled fill pattern in error area/bands) and the replication (dotted-and-dashed line with downward diagonal fill pattern in error area/bands) as well as adaptive false positives from the original study (dashed line with upward diagonal fill pattern in error area/bands) and time-based false positives from the replication (dotted line with grid fill pattern in error area/bands). Error areas/bands correspond to one standard error of the mean.

In some examples, model performance may differ between individual and group models. In a supplemental analysis, the inventors also compared the performance of the group model and the individual model for each participant. This was a useful comparison to determine whether a group model could be used as a cold start model in a system that had not yet been personalized. The inventors did this for the group and individual models containing all features for simplicity.

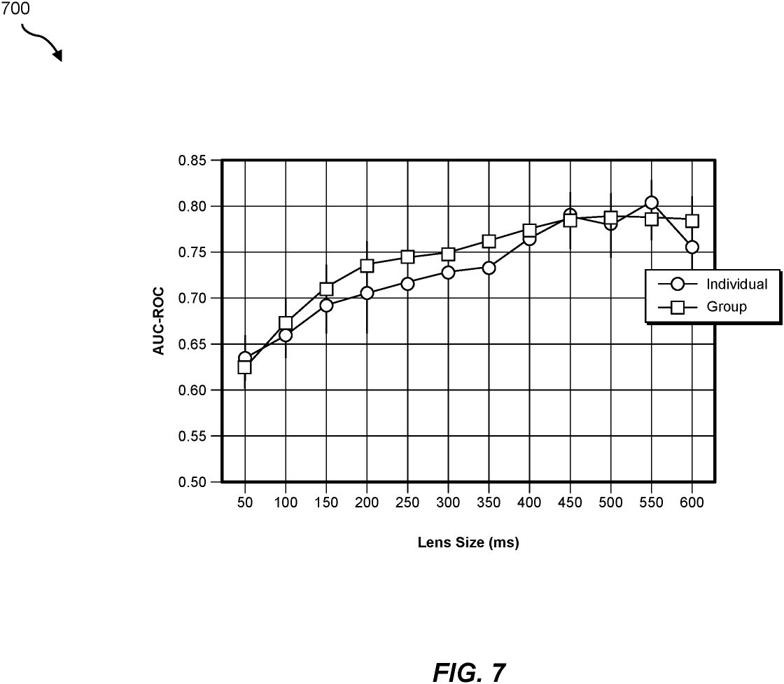

FIG. 7 shows a plot 700 that shows the individual model results and the group model results. As shown in plot 700, overall, paired t-tests at each lens size show no significant difference between group model and individual model using the FDR family-wise correction ps > 0.05).

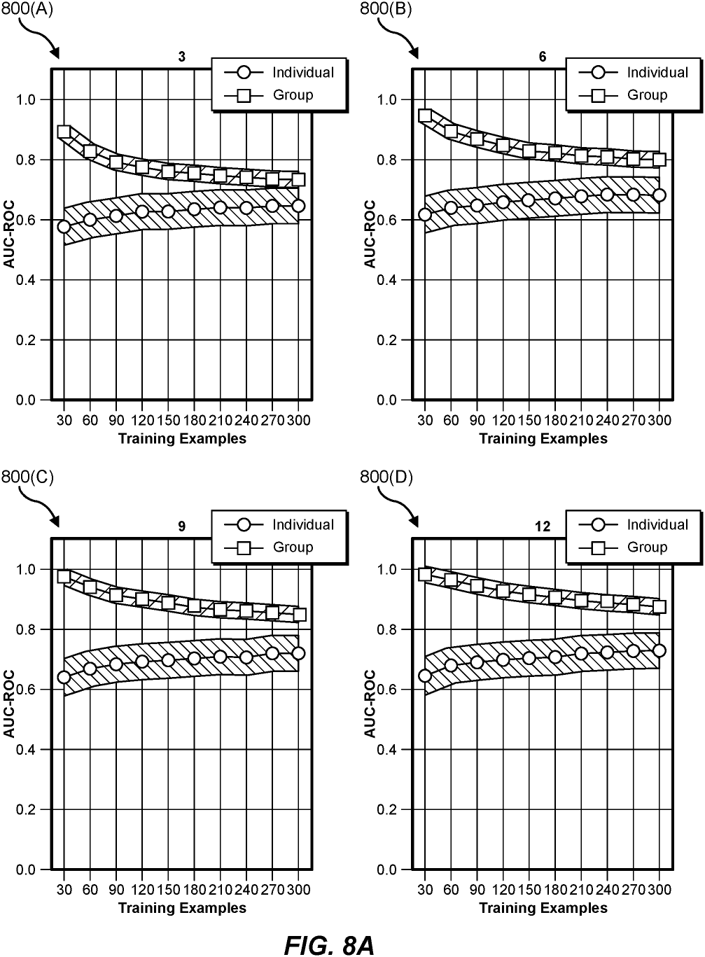

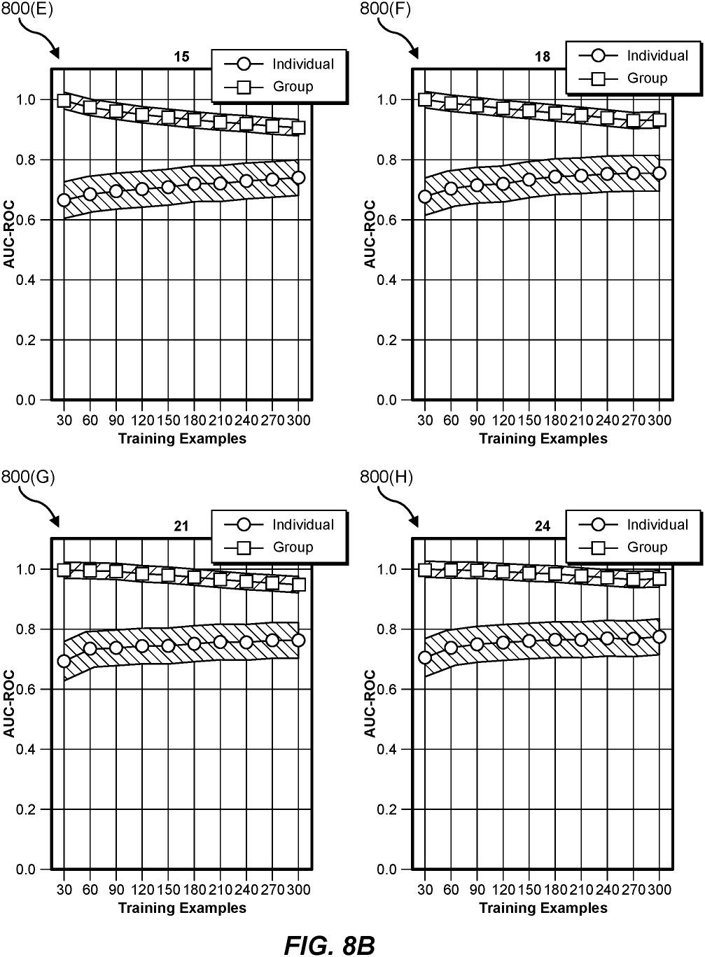

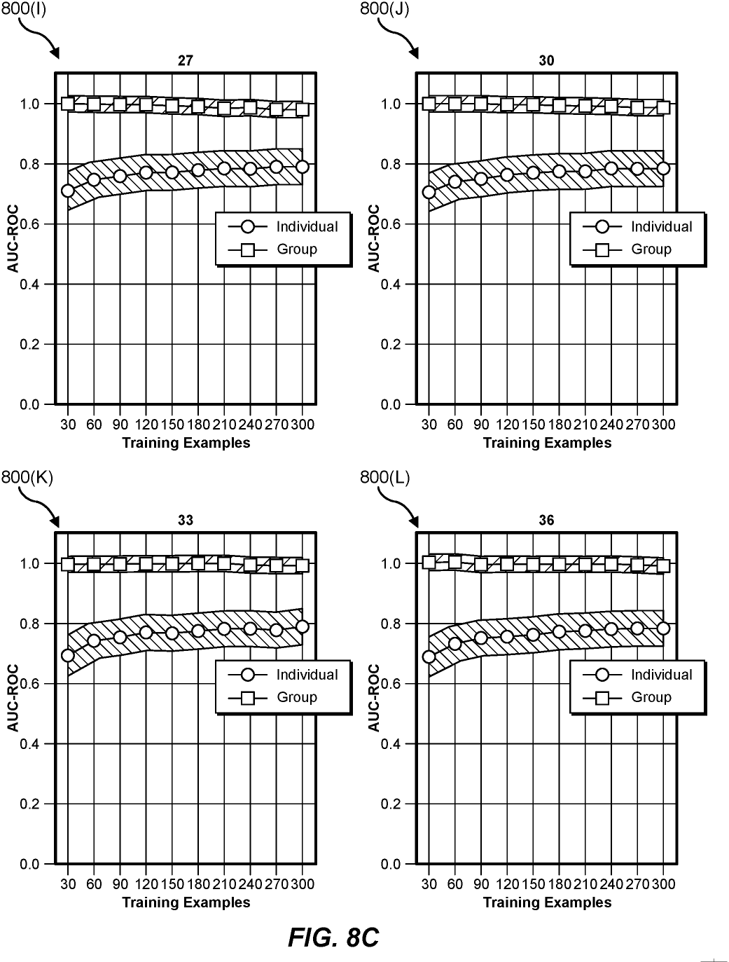

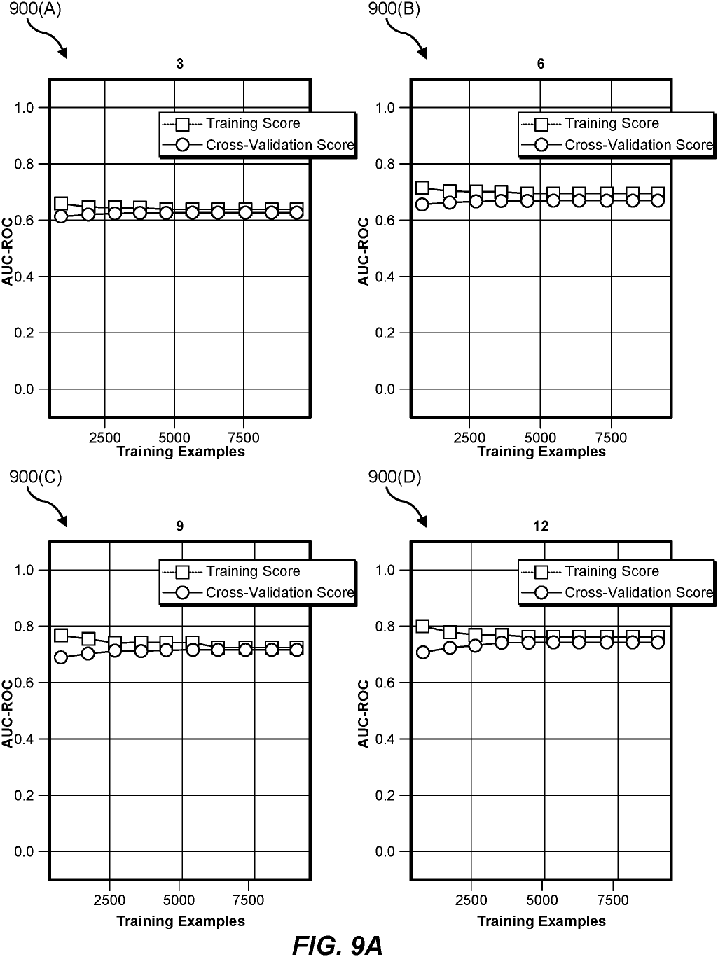

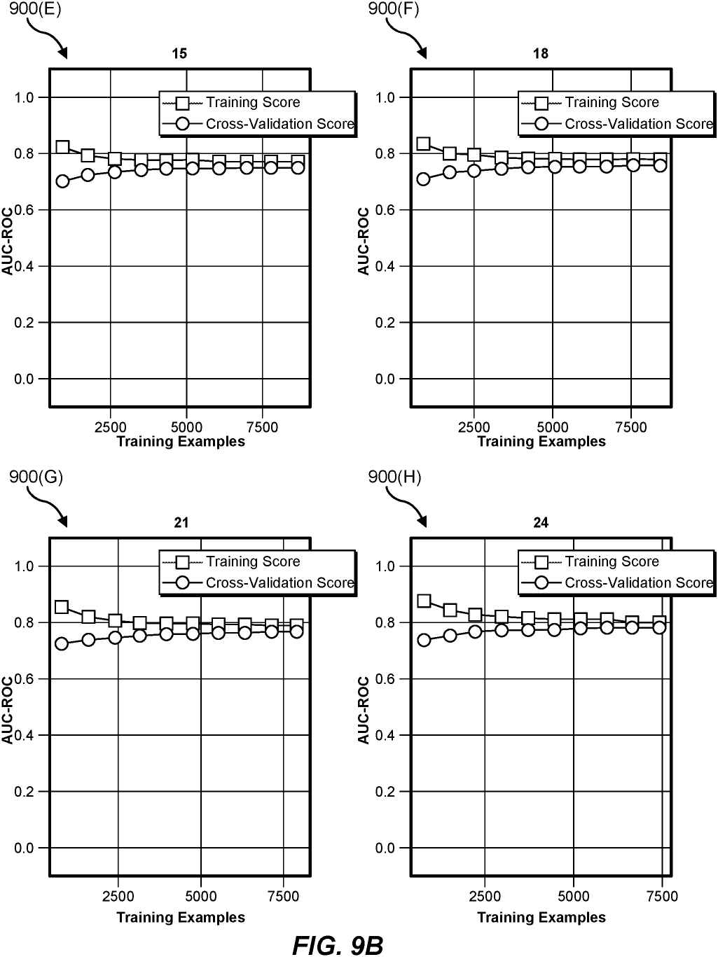

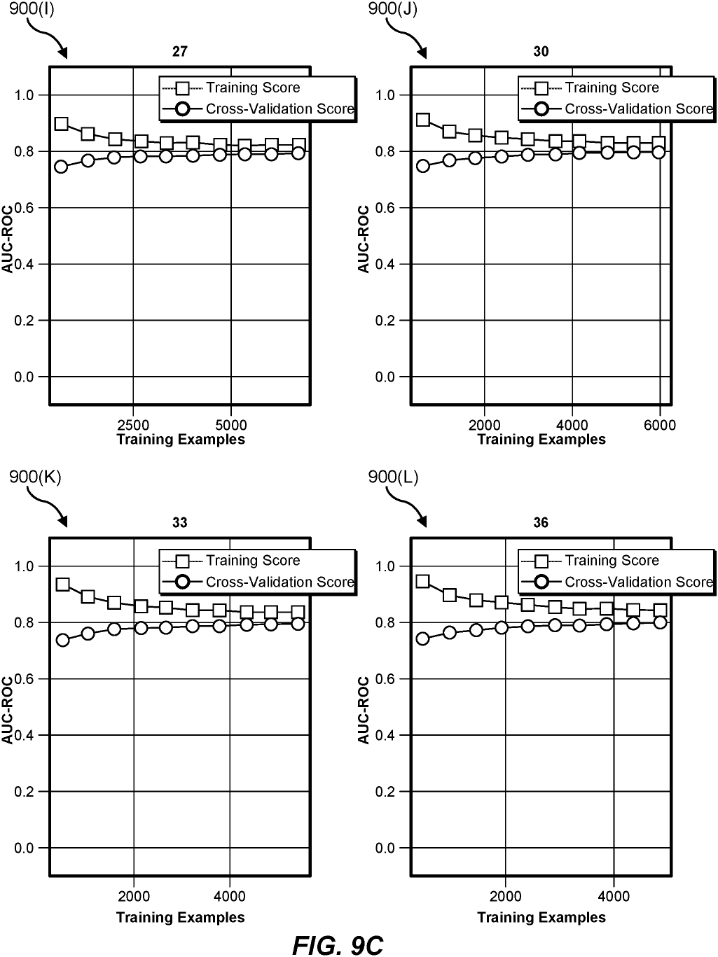

Because it would be expected that the individual model should perform better than the group model, the inventors investigated this further by computing learning curves for the training set and the cross-validation set. FIGS. 8A through 8C show a set of plots 800 (e.g., plot 800(A) through plot 800(L)) of individual model averaged learning curves. Likewise, FIGS. 9A through 9C show a set of plots 900 (e.g., plot 900(A) through plot 900(L)) of group model learning curves. Overall, the results showed that the group model had enough data but that the individual models would benefit from having more data. This suggests that although there was no significant difference in model performance between the group and individual models, the individual models would likely perform better than the group models if there was sufficient data to train the model.

In some examples, the lens model may be resilient to Ul changes and task changes following TP selections. An additional follow-up analysis tested whether the inventors’ model was resilient to changes in the user interface (Ul) and task following true positive selections. This was important to test because it could be the case that the inventors’ model learned behaviors that were specific to the Ul and task rather than behaviors that were general across Uls and tasks.

The inventors tested whether the model was resilient to changes in the Ul and task using true positive selections that occurred in the middle of the trial (serial true positives) and true positive selections that occurred at the end of the trial (end true positives). Serial true positives were followed by a new selection whereas end true positives were followed by the tiles shuffling at the end of the trial.

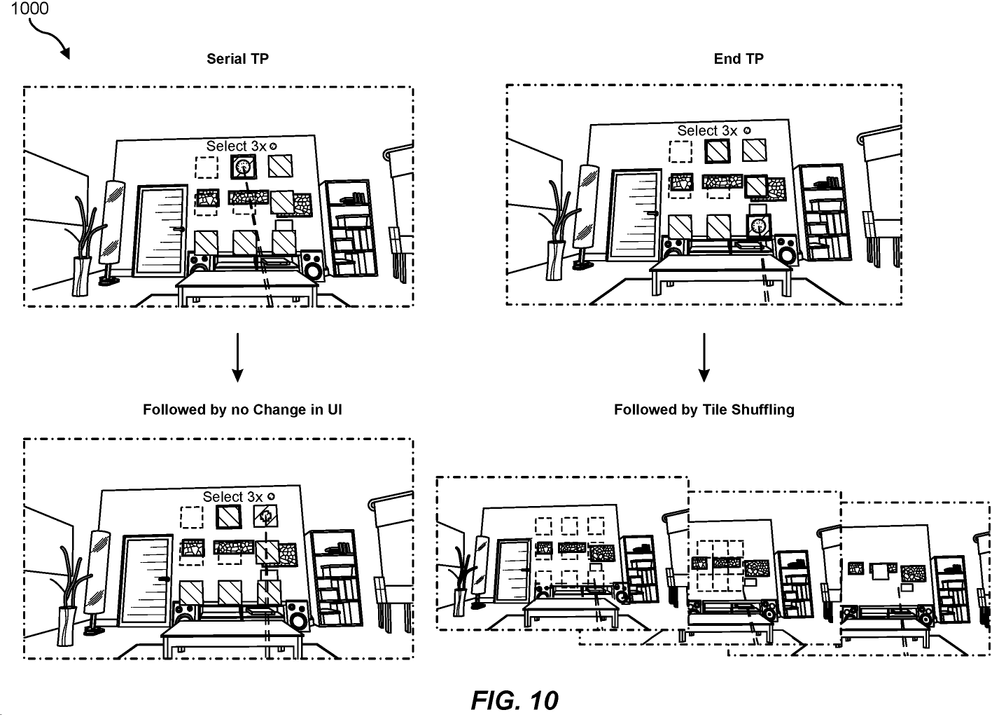

FIG. 10 shows a visualization 1000 of UI changes following serial true positives and end true positives. As shown, following serial true positives, there was no change in user interface as people selected a new tile. Following end true positives, however, the user interface changed, as tiles shuffled to indicate a new trial was going to occur.

Furthermore, serial true positives had a different task than end true positives. Here, there was an expectation to move the eyes to select another tile following serial true positives whereas there was no expectation to move the eyes to a new selection after end true positives since the trial was over. Given how different the Ul and task were following serial and end true positives, this provided a test of how stable model performance was.

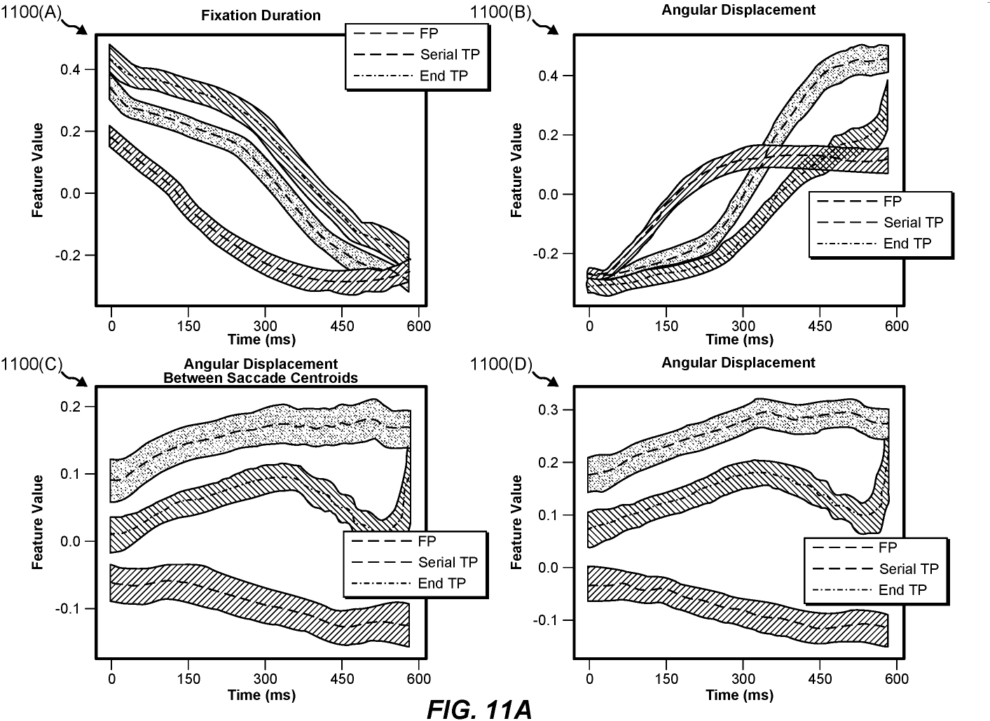

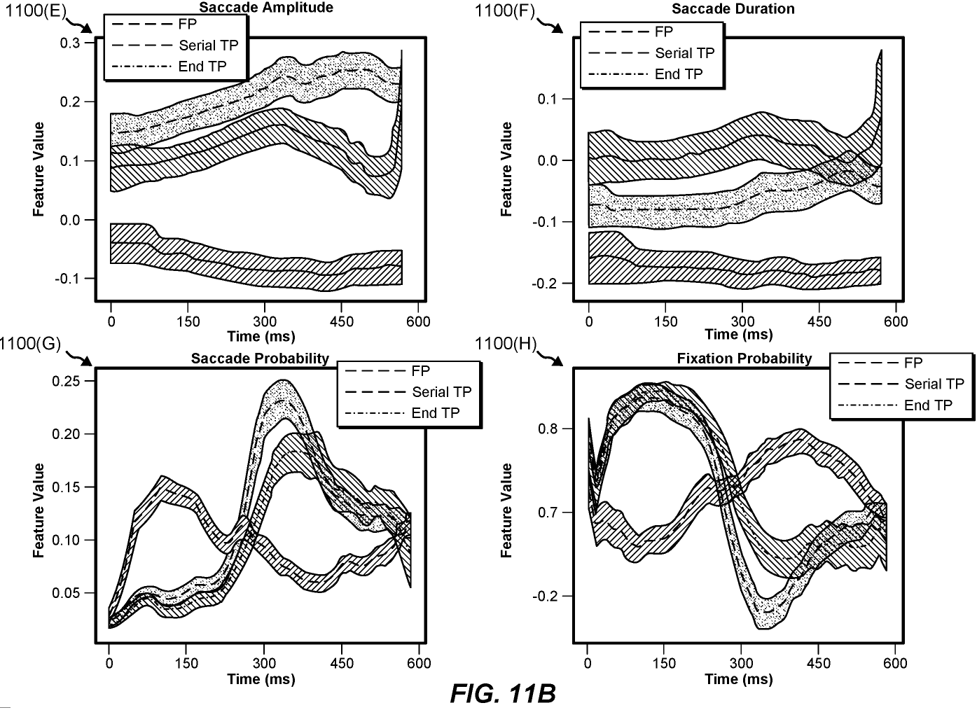

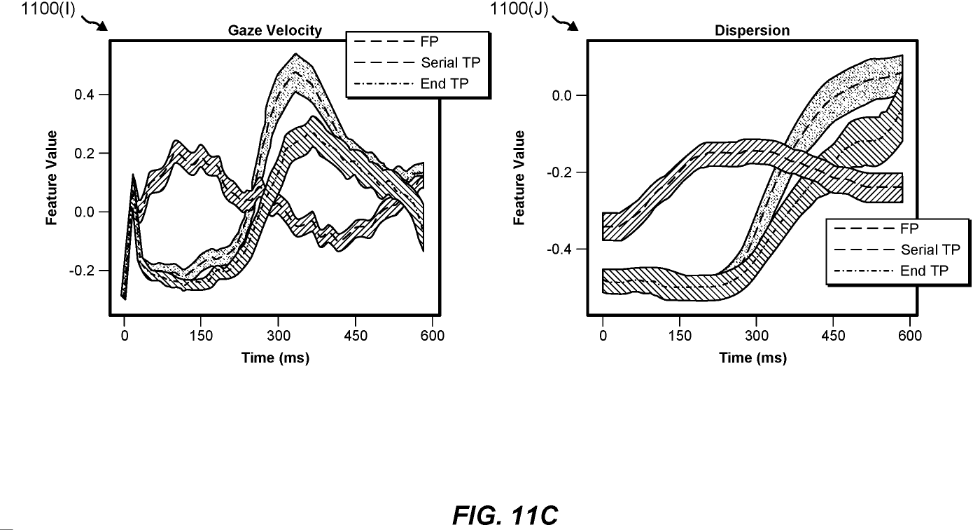

Additionally, the inventors tested whether the group model that had seen serial true positives only performed differently on end true positives. Importantly, the end true positives were not included in the trained model, only the test data. FIGS. 11A through 11C show a set of plots 1100 (e.g., plot 1100(A) through plot 1100(J)) that visualize the time series of the serial true positives and end true positives for each feature. The plots visualize the time series of the fixation features, saccade features, and continuous features following serial true positive selections (dashed line with speckled fill pattern in error area/bands), end true positive selections (dotted-and-dashed line with downward diagonal fill pattern in error area/band), and false positive selections (dashed line with upward diagonal fill pattern in error area/bands). Error areas/bands correspond to one standard error of the mean. Overall, the relationship between end true positives and false positives was similar to that of the serial true positives and false positives.

When considering the individual features model, the fixation duration model performed better on end true positives than serial true positives for all time points (FDR ps < 0.05) except for 600 ms (FDR ps > 0.05) according to a paired t-test. This is likely because end true positives appeared more separable from false positives than serial true positives. For the angular displacement between the previous and current fixation centroid, the model performed significantly better on end true positives than serial true positives at lens size 200 (FDR ps < 0.05). Conversely, the model was better able to separate serial true positives from false positives at lens size 350, 400, and 450 (FDR ps < 0.05). All other lens sizes were not significantly different (FDR ps > 0.05). For the angular displacement between the previous and current saccade centroid and the angular displacement between the previous and current saccade landing points, the model performed significantly better on serial true positives than end true positives for all time points except for 600 ms. The model performed no differently on serial true positives versus end true positives when considering the probability of saccade, probability of fixation, and gaze velocity. For dispersion, the model was better able to separate serial true positives from false positives than end true positives from false positives at time points 400 and 450 ms (FDR ps < 0.05). All other time points were not significantly different.

Turning to the all-features model, there was no significant difference between model performance when the group model was tested on serial true positives or end true positives for any of the lens sizes via paired t-tests (FDR ps > 0.05). This suggests that the model was able to discriminate false positives from true positives regardless of whether the Ul or task changed.

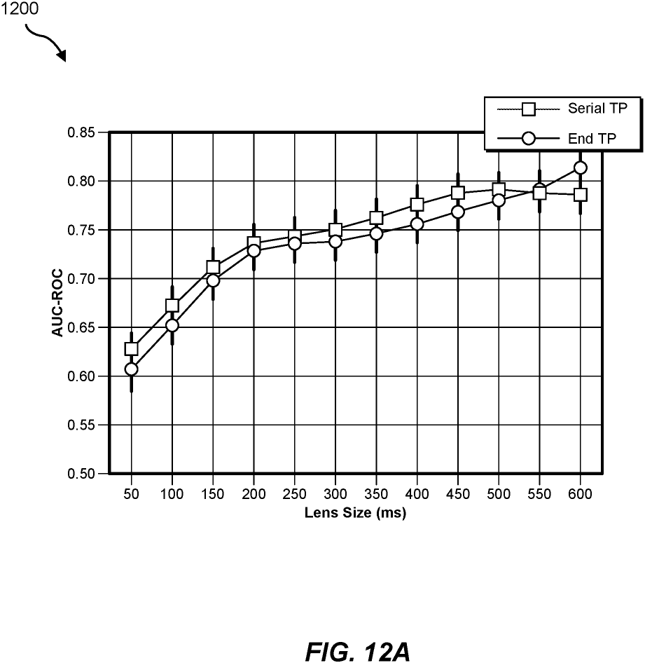

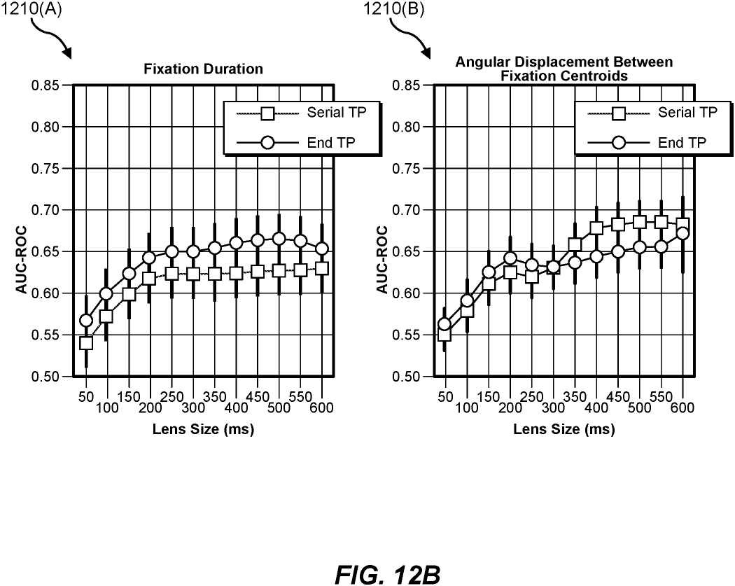

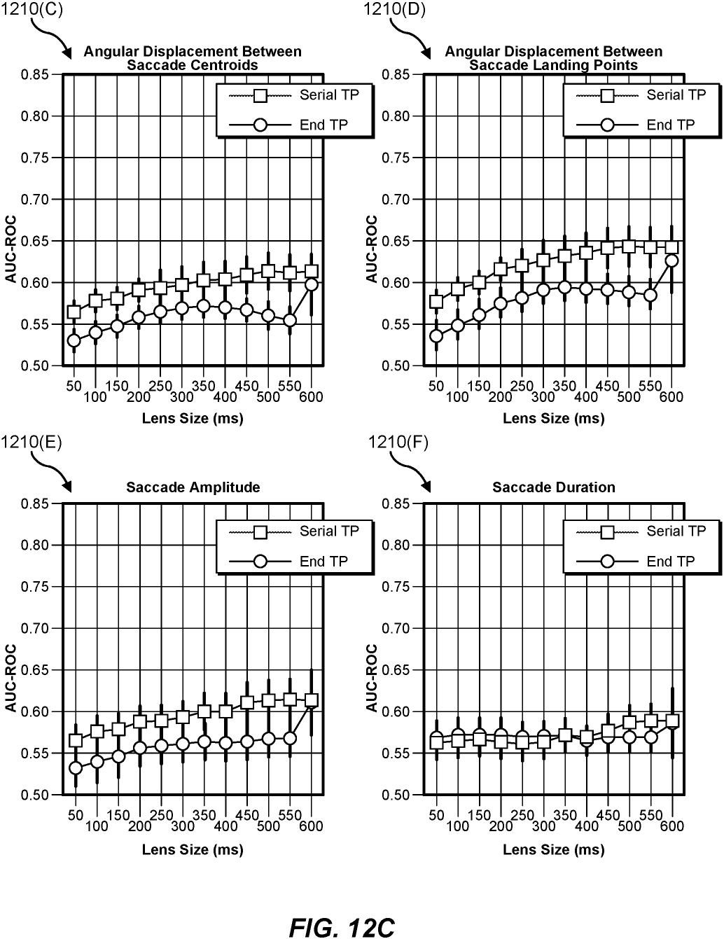

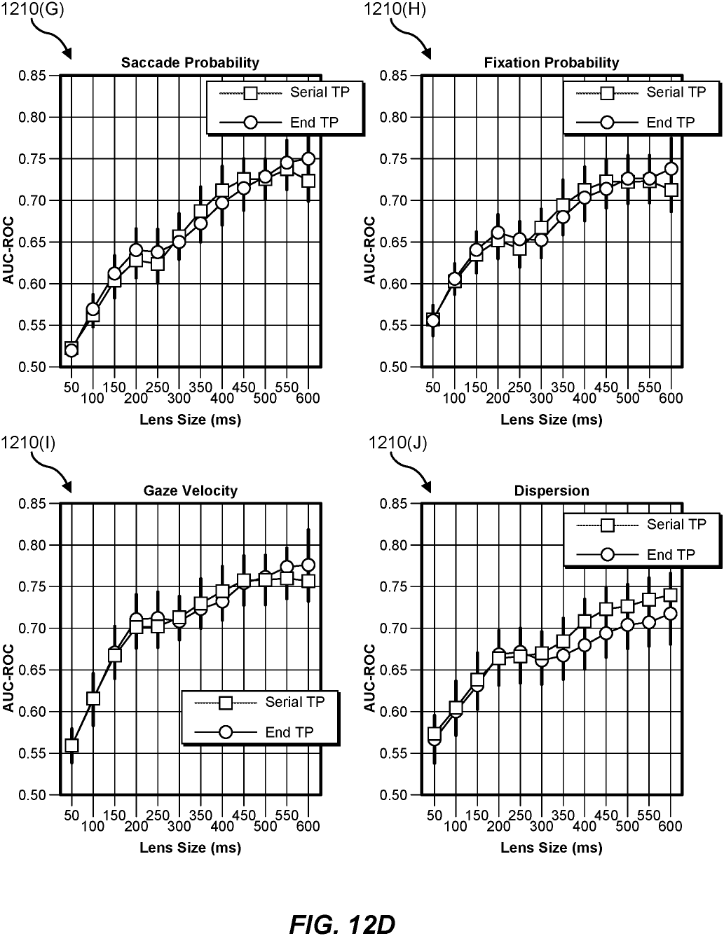

FIGS. 12A through 12D include a set of plots of AUC-ROC scores when the group model is tested on serial true positives and end true positives. Plot 1200 shows the AUC-ROC values when the group model (that has only seen serial true positives) is tested on serial true positives and end true positives at each lens size when considering all features in the group model. Plots 1210 (e.g., plot 1210(A) through plot 1210(J)) show the AUC-ROC values for the serial true positives and the end true positives each individual feature at each lens size. Error bars refer to confidence intervals.

Together, these results suggest that changes in the Ul and task do not largely change model performance. For the majority of features, there was no difference between true positives when the Ul or task changes which is likely driving the lack of difference in the all features model. The features that were most affected were the saccade features and fixation durations. Changes in task might influence saccade features as people executed new eye movements to select a new tile following serial true positives but not following end true positives. This might have resulted in a lower magnitude of difference between end true positives and false positives than between serial true positives and false positives. Fixation durations were longer following end true positives than serial true positives. Because people have no need to move their eyes following end true positives, they may fixate for longer following end true positives than following serial true positives. Regardless of these differences, however, the direction of the serial and end true positives relative to false positives is the same which suggests that the inventors’ findings are likely capturing gaze behaviors as they relate to true selections generally rather than changes in the Ul and task.

These findings provide initial evidence that the inventors’ results reflect gaze behaviors as they relate to error injection generally and that this effect is likely not due to changes in the Ul or task.

An additional potential confound in the inventors’ initial experiment was the method in which errors were injected. Errors were injected randomly within 200 and 500 ms of tile opening, or when the participant’s cursor left the bounds of the tile. Because the inventors knew that gaze motion correlates to hand motion, this latter criterion might have introduced a confound. To address this concern, the inventors reran the experiment without this contingency; here, the inventors randomly injected false positives based upon time alone (200 to 500 ms after a tile opened). A subset of the original study participants were ran on this replication study so that the inventors could compare whether behaviors changed as a function of how errors were injected.

Two group models were then trained. One group model was trained using the matched original study participants and a second was trained using the replication study participants at each lens size. Each of these models was tested using leave one out cross-validation. the inventors then compared the resulting AUC-ROC values for group models that were trained on individual features and group models that were trained on all features.

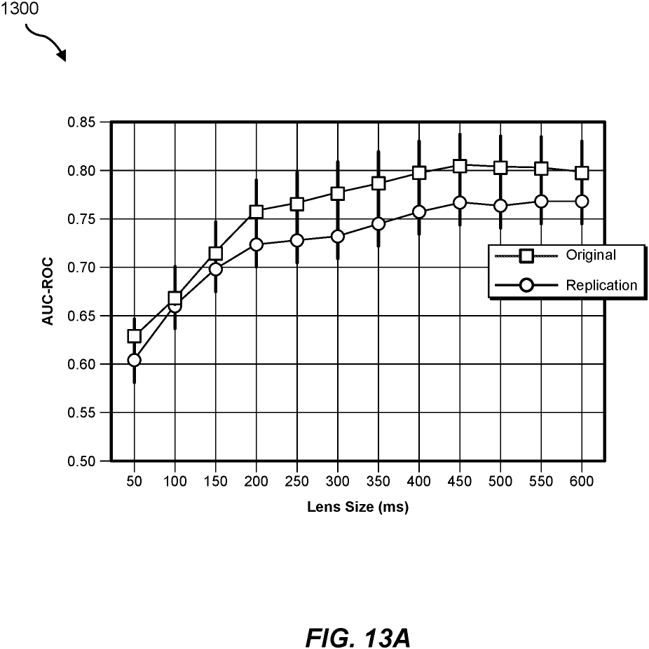

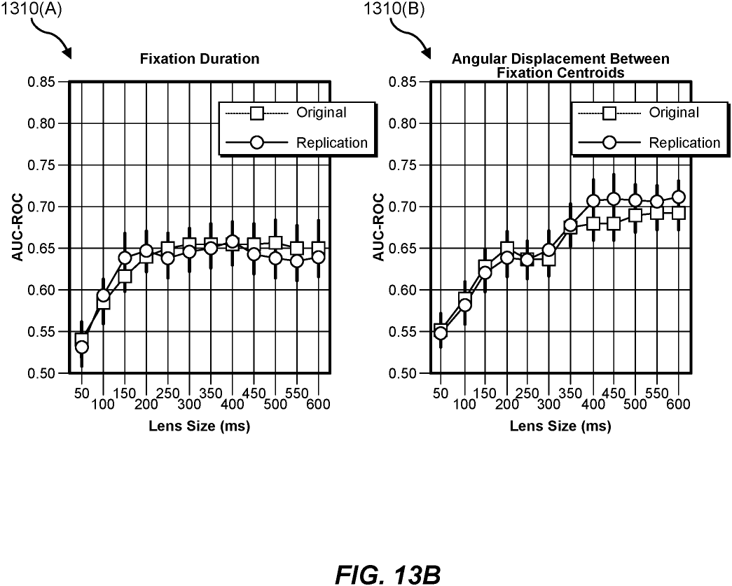

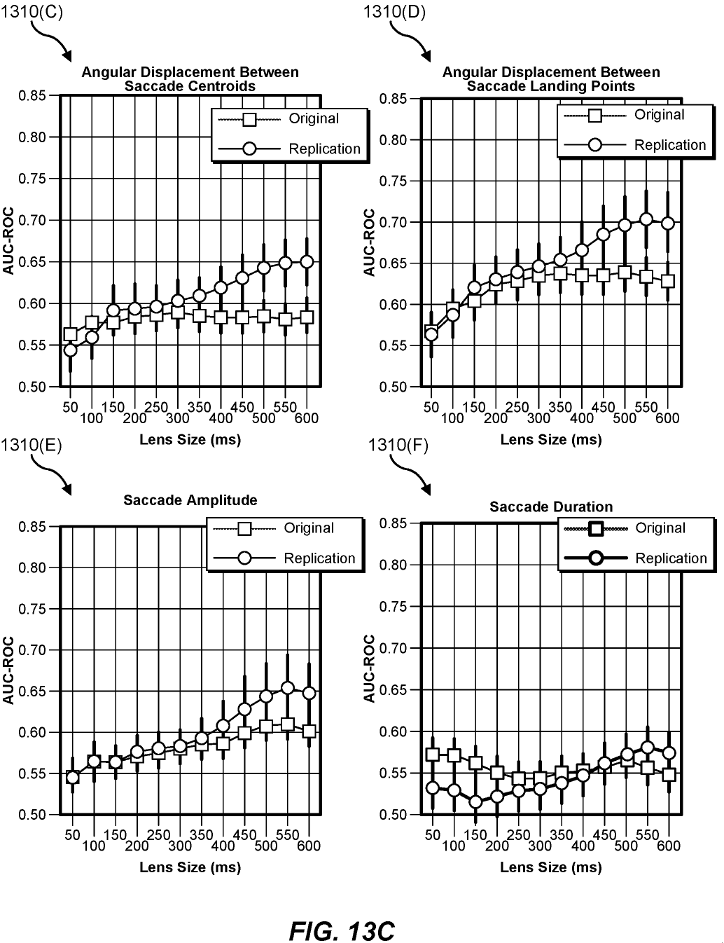

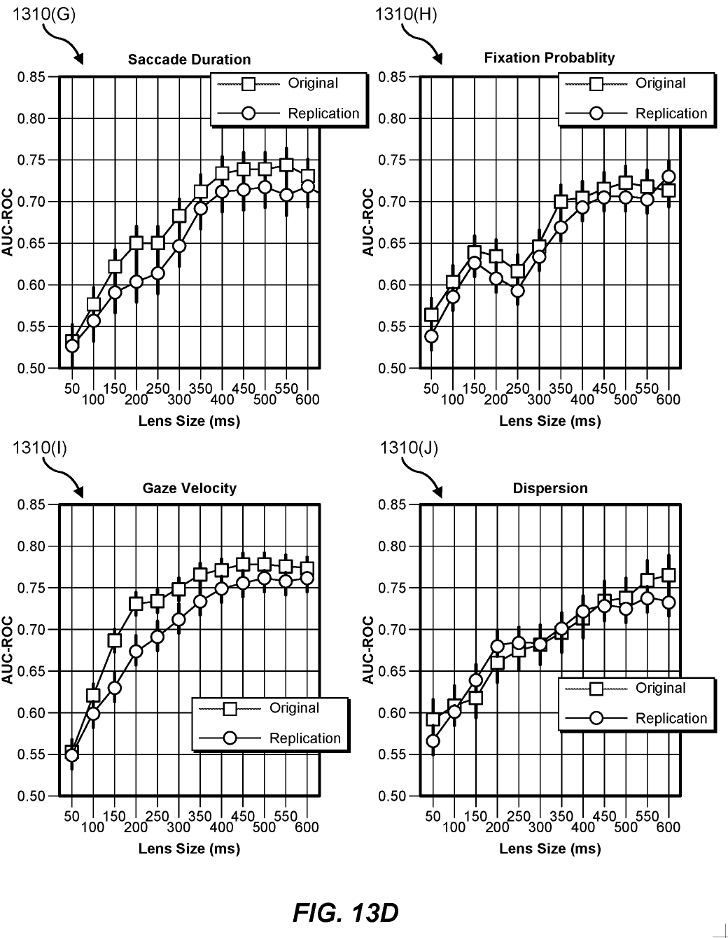

FIGS. 13A through 13D show a set of plots of AUC-ROC scores for the matched original and replication study participants. Plot 1300 in FIG. 13A shows the AUC-ROC values for the matched original and replication participants when considering all features simultaneously. Plot 1310(A) through plot 1310(J), included in FIG. 13B through FIG. 13D, show the AUC-ROC values for the original and replication studies for each feature at each lens size. Error bars refer to confidence intervals.

When considering the group models trained on individual features, there was no significant difference between AUC-ROC scores for each lens size and each feature via paired t-tests (all FDR ps > 0.05). For the original study participants, the AUC-ROC scores for each feature were significant at each time point (FDR ps < 0.05) except for fixation durations at 50 ms and gaze velocity at 50 ms (FDR ps > 0.05) according to one-sample t-tests. For the replication participants, the AUC-ROC scores for each feature at each lens size were significantly greater than chance (FDR ps < 0.05) except for fixation durations at 50 ms and saccade durations from 100 to 450 ms in the replication when considering one-sample t-tests (FDR ps > 0.05).

For group models trained on all features, there were no significant differences between the AUC-ROC values at each lens size between the matched original study group and the replication group when considering paired t-tests (all FDR ps > 0.05). The original and replication models each performed significantly better than chance at each lens size when considering one-sample t-tests (all FDR ps < 0.05).

Overall, the combined feature results and individual feature results replicated except for saccade durations. Because the results did not change as a function of how errors were injected, this suggests that the inventors’ model is likely capturing gaze behaviors as they relate to errors rather than due to task artifacts. Saccade durations might not have replicated, as their time series were generally noisier than the other features. This might be due to the low sampling rate of the commercial eye-tracker used in the study rather than behaviors related to errors. Given that the group model of saccade durations using all 29 participants in the original study performed significantly above chance at all lens sizes, it might simply be the case that more data is needed when modeling saccade durations since these are generally a noisier feature. Regardless of this anomaly, however, this finding provides strong evidence that the inventors’ model has captured gaze behaviors as they relate to error detection rather than task artifacts.

The goal of the foregoing study and supplemental investigations was to explore whether natural gaze dynamics could be used to detect system-generated errors, and, if so, how early these errors could be detected using gaze alone.

The inventors discovered that gaze features varied consistently following true selection events versus system-generated input errors. In fact, using gaze features alone, a simple machine learning model was able to discriminate true selections from false ones, demonstrating the potential utility of gaze for error detection. Importantly, the inventors found that the model could detect errors almost immediately (e.g., at 50 ms, 0.63 AUC-ROC), and that decoding performance increased as time continued (e.g., at 550 ms, 0.81, AUC-ROC). The model performance peaked between 300 ms and 550 ms, which suggests that systems might be able to leverage gaze dynamics to detect potential errors and provide low-friction error mediation.

Although there were no significant differences between the performance of the individual and group models, Supplementary analysis indicated that the individual models might benefit from more data and would likely surpass the group models in performance with more data. This result is not surprising because there are considerable individual differences in how users move their eyes. Models that account for these differences are likely to outperform a generic model. That said, the inventors’ results provide compelling evidence that a group model could assist with system-generated error detection from the moment of unboxing.

The results demonstrated a pattern of increased eye motion immediately following false positive selections, which likely captures users’ orienting of their attention to other targets. Indeed, when a false selection is registered, users are likely already enroute to the next tile, just as they would be in a real system with a model-based gesture recognizer or some other inference-based input device. Additionally, as users detect the error, it is likely that they will abandon their current plan to reorient their attention to the erroneously selected object. This reorientation is evidenced in FIGS. 3A through 3D between 300 and 550 ms, where saccade probability sharply increases, angular displacement increases, and gaze velocity and dispersion increase. Together, these gaze behaviors suggest that users are changing course in their gaze trajectory (i.e., angular displacement) and rapidly moving their eyes back to the erroneous selection (i.e., saccade, velocity, and dispersion features).

Together, the findings suggest that the model is capturing two types of signals as they relate to true and false selections. First, gaze behaviors that occur immediately after a selection reflect attention (or lack of) to the selected target. These behaviors occur within milliseconds of selection as evidenced by H1 (FIGS. 3A through 3D). Second, the inventors’ model is likely capturing gaze behaviors related to noticing the error, which likely reflect attention to feedback and recognition of the need to reorient to the target to correct the error. These can be seen at later time frames in the figures provided herein (e.g., 300 ms to 450 ms).

The inventors’ findings align with cognitive psychology literature on gaze in response to expectation. This literature demonstrates that when the inventors’ expectations of what belongs in the world are violated, eye movements are affected. In the present disclosure, the inventors provide the first evidence that gaze is also sensitive to system-generated errors, which are by definition violations of expectation.

The inventors’ findings make intuitive sense with how users orient their gaze following true selections and false positive errors across interaction tasks. Indeed, the inventors’ tile task mimics a broad class of situations (e.g., photo selection, movie selection, typing on calculator) where false positives occur in practice. Here, a user might have focused attention on an interface element (e.g., a movie preview) but decided not to interact with it (e.g., select the movie). Here, errors occur as their gaze is mid-flight to another selection (e.g., a movie is falsely selected). Once they receive feedback (e.g., the movie starts playing), they must reorient their gaze back to the erroneously selected target. While the inventors’ study provided the first proofof-concept that gaze is sensitive to errors and needs to be confirmed with future work, the pattern of behaviors observed leads us to believe that this pattern would generalize to new tasks and interfaces.

Overall, the continuous and fixation features tended to produce stronger model performance than the saccade features. Saccades occur over a short time period due to their ballistic nature whereas the continuous and fixation features occur over longer periods of time. Because the sampling frequency of commercial eye-trackers is relatively low, this might result in a system missing or parsing saccade features with lower fidelity since they have fast time courses. Notwithstanding the foregoing, the inventors’ model performed very well despite the low sampling frequency of the commercial eye-tracker used. The model may perform even better once eye-tracking technology can capture gaze with a higher fidelity.

The findings of the inventors’ research have several implications for the design of recognition-based input systems. The capability to notice errors soon after they occur opens up a new design space for adaptive mediation techniques.

First, because false positive errors do not occur in response to an explicit user action and therefore require users to monitor for the occurrence of false positives, an input system could help the user with noticing these errors on the basis of gaze. For instance, systems might make it easier for users to “undo” immediately after an error.

Second, approaches to mitigating false positive errors in systems could be fused with the novel gaze models disclosed herein to increase accuracy of these models in working systems. For instance, if scores are close to the recognizer threshold in a system, and gaze models detect that an error has occurred, then these scores could be fused to increase reliability of error detection. This would be particularly useful if there was noise in either the recognizer or the gaze model.

Finally, the present study found that gaze is sensitive to user input following a selection. Because gaze is sensitive to the onset and offset of intentional user input, this suggests that by treating user behaviors continuously (e.g., capturing user behavior before, during, and after an event), systems may produce stronger model performance than if they treat these behaviors as a one-off event.

The foregoing provides a novel empirical framework to understand whether and how gaze responds to system-generated errors. Overall, the inventors found that gaze is sensitive to error injection from the earliest moments in time, a finding that has potential for use in adaptive systems described in additional detail below.

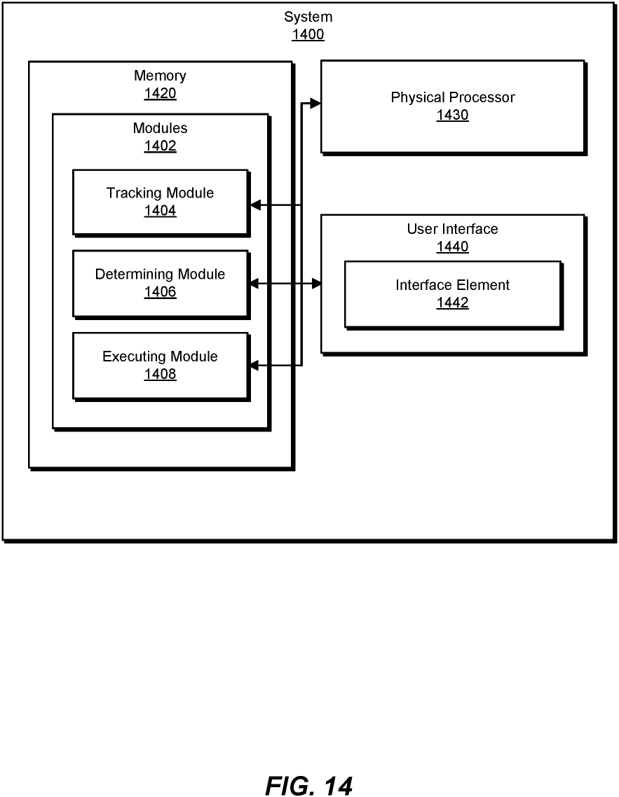

FIG. 14 is a block diagram of an example system 1400 for using natural gaze dynamics to detect input recognition errors. As illustrated in this figure, example system 1400 may include one or more modules 1402 for performing one or more tasks. As will be explained in greater detail below, modules 1402 may include a tracking module 1404 that tracks a gaze of a user as the user interacts with a user interface (e.g., user interface 1440, described below). Example system 1400 may also include a determining module 1406 that determines, based on tracking of the gaze of the user, that a detected user interaction with the user interface represents a false positive input inference by the user interface. Likewise, example system 1400 may also include an executing module 1408 that may execute at least one remedial action based on determining that the detected user interaction represents the false positive input inference by the user interface.

As further illustrated in FIG. 14, example system 1400 may also include one or more memory devices, such as memory 1420. Memory 1420 generally represents any type or form of volatile or non-volatile storage device or medium capable of storing data and/or computer-readable instructions. In one example, memory 1420 may store, load, and/or maintain one or more of modules 1402. Examples of memory 1420 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 14, example system 1400 may also include one or more physical processors, such as physical processor 1430. Physical processor 1430 generally represents any type or form of hardware-implemented processing unit capable of interpreting and/or executing computer-readable instructions. In one example, physical processor 1430 may access and/or modify one or more of modules 1402 stored in memory 1420. Additionally or alternatively, physical processor 1430 may execute one or more of modules 1402 to facilitate using natural gaze dynamics to detect input recognition errors. Examples of physical processor 1430 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also shown in FIG. 14, example system 1400 may also include a user interface 140 with an interface element 142. As described herein, example system 1400 may track a gaze of a user as a user interacts with user interface 1440 and/or user interface element 1442. User interface 1440 may include and/or represent any suitable user interface including, without limitation, a graphical user interface, an auditory computer interface, a tactile user interface, and so forth.

Many other devices or subsystems may be connected to system 1400 in FIG. 14. Conversely, all of the components and devices illustrated in FIG. 14 need not be present to practice the embodiments described and/or illustrated herein. The devices and subsystems referenced above may also be interconnected in different ways from those shown in FIG. 14. System 1400 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium. Example system 1400 in FIG. 14 may be implemented in a variety of ways. For example, all or a portion of example system 1400 may represent portions of an example system 1500 (“system 1500”) in FIG. 15. As shown in FIG. 15, system 1500 may include a computing device 1502. In at least one example, computing device 1502 may be programmed with one or more of modules 1402.

In at least one embodiment, one or more of modules 1402 from FIG. 14 may, when executed by computing device 1502, enable computing device 1502 to track a gaze of a user as the user interacts with a user interface. For example, as will be described in greater detail below, tracking module 1404 may cause computing device 1502 to track (e.g., via an eye tracking subsystem 1508) a gaze (e.g., 1504) of a user (e.g., user 1506) as the user interacts with a user interface (e.g., user interface 1440). In some examples, tracking module 1404 may track the gaze of the user by extracting at least one gaze feature (e.g., gaze feature 1510) from the gaze of the user.

Additionally, in some embodiments, determining module 1406 may cause computing device 1502 to determine, based on tracking of the gaze of the user, that a detected user interaction with the user interface (e.g., detected user interaction 1512) represents a false positive input inference (e.g., “false positive 1514” in FIG. 5) by the user interface. Furthermore, in at least one embodiment, executing module 1408 may cause computing device 1502 to execute at least one remedial action (e.g., remedial action 1516) based on determining that the detected user interaction represents the false positive input inference by the user interface.

Computing device 1502 generally represents any type or form of computing device capable of reading and/or executing computer-executable instructions. Examples of computing device 1502 may include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

In at least one example, computing device 1502 may be a computing device programmed with one or more of modules 1402. All or a portion of the functionality of modules 1402 may be performed by computing device 1502. As will be described in greater detail below, one or more of modules 1402 from FIG. 14 may, when executed by at least one processor of computing device 1502, may enable computing device 1502 to use natural gaze dynamics to detect input recognition errors.

Many other devices or subsystems may be connected to system 1400 in FIG. 14 and/or system 1500 in FIG. 15. Conversely, all of the components and devices illustrated in FIGS. 14 and 15 need not be present to practice the embodiments described and/or illustrated herein. The devices and subsystems referenced above may also be interconnected in different ways from those shown in FIG. 15. Systems 1400 and 1500 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 16 is a flow diagram of an example computer-implemented method 1600 for allocating shared resources in multi-tenant environments. The steps shown in FIG. 16 may be performed by any suitable computer-executable code and/or computing system, including system 1400 in FIG. 1 and/or variations or combinations thereof. In one example, each of the steps shown in FIG. 16 may represent an algorithm whose structure includes and/or is represented by multiple sub-steps, examples of which will be provided in greater detail below.

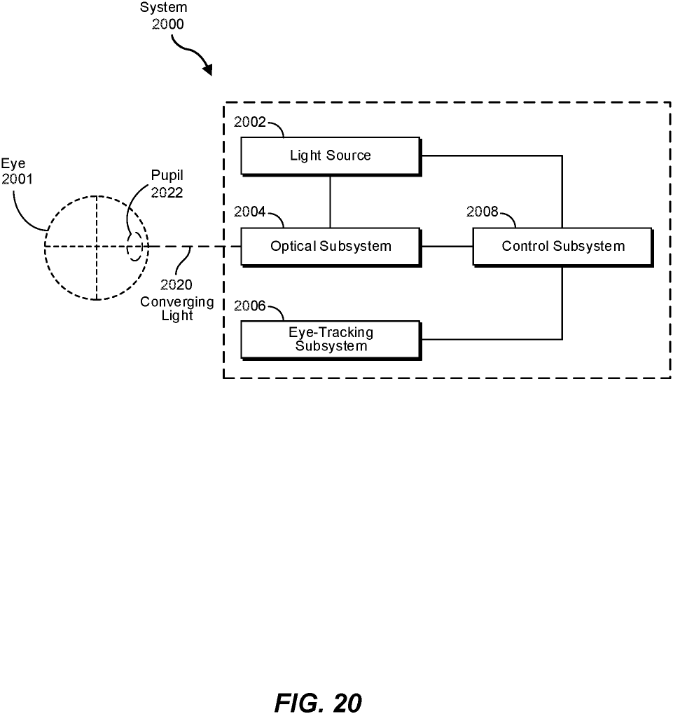

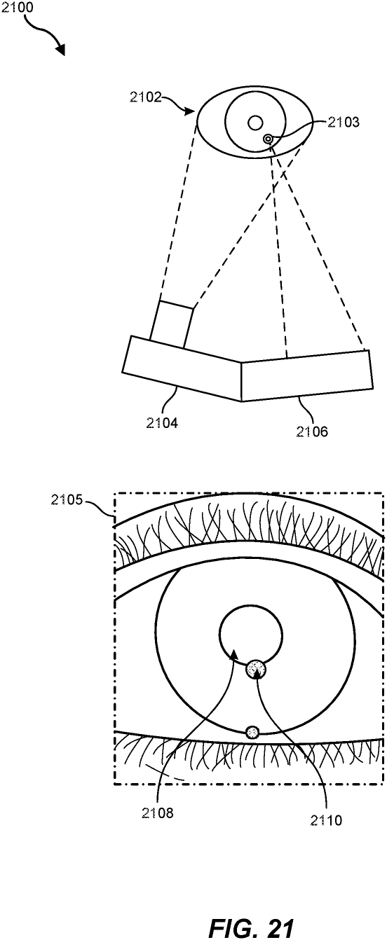

As illustrated in FIG. 16, at step 1610, one or more of the systems described herein may track a gaze of a user as the user interacts with a user interface. For example, tracking module 1404 in FIG. 14 may, as part of computing device 1502 in FIG. 15, cause computing device 1502 to track gaze 1504 of user 1506 as user 1506 interacts with user interface 1440. Tracking module 1404 may track gaze 1504 in any suitable way, such as via an eye tracking subsystem 1508. Additional explanations, examples, and illustrations of eye tracking subsystems will be provided below in reference to FIGS. 20 and 21.

At step 1620, one or more of the systems described herein may determine, based on tracking of the gaze of the user, that a detected user interaction with the user interface represents a false positive input inference by the user interface. For example, determining module 1406 in FIG. 14 may, as part of computing device 1502 in FIG. 15, cause computing device 1502 to determine, based on tracking of the gaze of the user (e.g., by tracking module 1404 and/or eye tracking subsystem 1508), that detected user interaction 1512 with user interface 1440 represents a false positive input inference 1514 by user interface 1440.

Determining module 1406 may determine that detected user interaction 1512 represents a false positive input inference 1514 in a variety of contexts. For example, as described above in reference to FIGS. 1-14, one or more of modules 1402 may extract at least one gaze feature from tracking data generated by tracking module 1404 (e.g., via eye tracking subsystem 1508). As described above, a gaze feature may include, without limitation, a fixation duration, an angular displacement between an initial fixation centroid and a subsequent fixation centroid, an angular displacement between an initial saccade centroid and a subsequent saccade centroid, an angular displacement between an initial saccade landing point and a subsequent saccade landing point, an amplitude of a saccade, a duration of a saccade, a fixation probability, a saccade probability, a gaze velocity, a gaze dispersion, and so forth.

Determining module 1406 may use gaze features of user 1506 and/or gaze features of a group of users to train a machine learning model to discriminate between true positive events and false positive events in any of the ways described herein, such as those disclosed above in reference to FIGS. 1-14. Determining module 1406 may further analyze the tracked gaze of user 1506 using the trained machine learning model in any of the ways described herein, such as those disclosed above in reference to FIGS. 1-14. This may enable determining module 1406 to determine that a detected user interaction with a user interface (e.g., detected user interaction 1512) represents a false positive input inference (e.g., false positive input inference 1514).

At step 1630, one or more of the systems described herein may execute at least one remedial action based on determining that the detected user interaction represents the false positive input inference by the user interface. For example, executing module 1408 in FIG. 14 may execute remedial action 1516 based on determining (e.g., by determining module 1406) that detected user interaction 1512 represents a false positive input inference (e.g., false positive 1514) by user interface 1440.

Executing module 1408 may execute a variety of remedial actions in a variety of contexts. As disclosed herein, the capability to detect when a gesture recognizer (e.g., tracking module 1404, user interface 1440, etc.) has made a false positive error could be used in a number of ways. For example, interactive meditation techniques may assist the user with error recovery.

When a false positive detected user interaction occurs as a user interacts with a user interface, the false positive may result in providing of unintended input to the system. If the system is configured to provide feedback associated with user input (e.g., visual feedback, haptic feedback, auditory feedback, etc.), the system may provide such feedback in response to the false positive. In addition, input resulting from the false positive may cause one or more changes to a state of an application associated with the user interface (e.g., selecting an item the user did not intend to select).

Executing module 1408 may execute one or more remedial actions to aid a user in error recovery. In some examples, error recovery may include cognitive and behavioral actions that a user must take in response to the consequences of an unintended input. For example, in the case where a false positive causes an item to be selected, the user may recover by identifying that an item has been unintentionally selected and de-selecting that item. In the case where no change to application state has occurred, error recovery may involve the user confirming that the unintended input did not change the application state.

Given that false positive errors occur in situations where the user does not intend to provide input to the system, a first step to error recovery for the user may be to notice that the error has occurred, and to understand whether and what changes to application state have been made as a result of the unintended input. Executing module 1408 may execute one or more remedial actions to aid the user by indicating that a false positive error may have occurred and highlighting any changes to an application state that may have resulted from the associated input to the system. For example, in a system where the user can select items, executing module 1408 may provide a glowing outline around recently selected objects, which may fade after a short period of time. Likewise, in some implementations, executing module 1408 may provide an indication that no change to application state has occurred as a result of a possible gesture FP error. This may help the user confirm that the input did not make any changes and remove any need for the user to confirm this by inspecting the interface for changes.

In some examples, where an input resulting from a false positive has resulted in changes to the application state, executing module 1408 may facilitate the user in reversing these changes. For example, executing module 1408 may display, within user interface 1440, a prominent button that, when interacted with by user 1506, may cause executing module 1408 to undo the change. Likewise, an undo action could be mapped to a micro-gesture or easy-toaccess button on an input device. Modern applications typically offer some means of reversing most changes to application state, but recovery facilitation techniques can provide benefit by providing more consistent means of reversing unintended results caused by false positive detected user interaction errors (e.g., the same method, across many system actions), and also by making the recovery action easier to perform (e.g., an ‘Undo’ button on a delete file operation, in place of a multi-action process of navigating to the Recycle Bin, locating the deleted file, and clicking Restore).

Additionally or alternatively, executing module 1408 may automatically reverse the changes to the application state on behalf of the user. In some embodiments, such automatic recovery operations may include and/or employ the previous techniques of notification and recovery facilitation. This may avoid, mitigate, or resolve some challenges that such automatic recovery operations may introduce.

In some examples, one or more of modules 1402 may further incorporate information on the user’s behavior over longer time scales to aid in detection and/or remediation of input errors. As an illustration, consider a situation where a user is selecting a set of photos to send in a message. If the user selects a photo of a cat, a photo of a receipt, and then three more cat photos, the receipt photo may stand out as clearly distinct from the others.

One or more of the systems described herein (e.g., one or more of modules 1402) may use this ‘semantic’ information on the user’s actions along with gaze information to produce a more holistic model of user actions and to determine whether detected user interactions represent false positives. For example, continuing with the foregoing illustration, one or more of modules 1402 (e.g., tracking module 1404, determining module 1406, executing module 1408, etc.) may gather and analyze gaze information and/or additional input information associated with photo selection behavior of user 1506 over time, building a model that can discriminate between intentional photo selection events and unintentional photo selection events. In response to the selection of the photo of the receipt mentioned above, one or more of modules 1402 (e.g., executing module 1408) may execute a remedial action where, upon clicking the send button, user interface 1440 may present a prompt that requests user 1506 to confirm that user 1506 intended to include the receipt photo. Executing module 1408 may further cause user interface 1440 to present user 1506 with an option to easily remove the receipt photo from the selection.

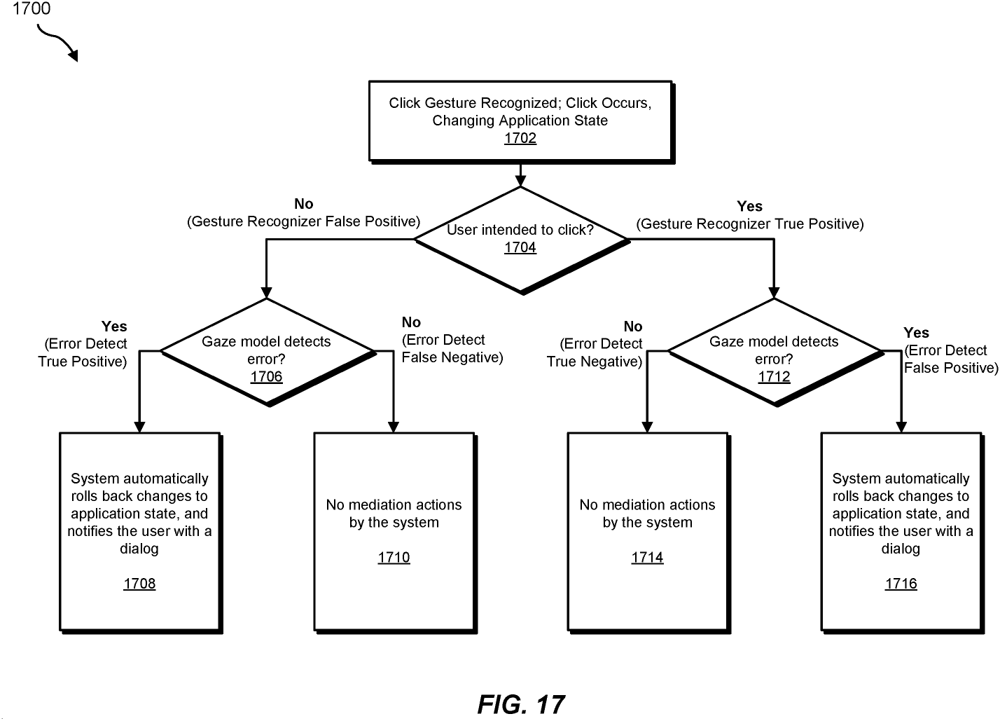

FIG. 17 includes a flow diagram 1700 that illustrates example remedial actions and/or effects on a user experience of an automatic error recovery operation. Beginning at process 1702, at process 1702, a user interface (e.g., user interface 1440) may recognize or receive a click gesture (e.g., detected user interaction 1512), register that a click has occurred, and change an application state.

At decision 1704, flow diagram 1700 distinguishes whether a user (e.g., user 1506) intended the user interface to recognize or receive the click gesture. If no (i.e., the user interface or gesture recognizer receives a false positive), at decision 1706, one or more of the systems described herein (e.g., determining module 1406) may determine whether a detection error has occurred. If yes (i.e., determining module 1406 determines that detected user interaction 1512 is a false positive), then, at process 1708, one or more of modules 1402 (e.g., executing module 1408) may execute a remedial action (e.g., remedial action 1516) by automatically undoing or rolling back changes to an application state and notifying the user with a dialog. If no, at process 1710 (i.e., determining module 1406 does not determine that detected user interaction 1512 is a false positive), the systems and methods described herein may execute no remedial action and/or an alternative action.

Returning to decision 1704, if yes (i.e., the user interface or gesture recognizer receives a true positive), at decision 1712, one or more of the systems described herein (e.g., determining module 1406) may determine whether a detection error has occurred. If no (i.e., determining module 1406 determines that detected user interaction 1512 is a true negative), then, at process 1714, the systems and methods described herein may execute no remedial action and/or an alternative action. If yes (i.e., determining module 1406 determines that detected user interaction 1512 is a false positive), one or more of modules 1402 (e.g., executing module 1408) may, at process 1716, execute a remedial action (e.g., remedial action 1516) by automatically undoing or rolling back changes to an application state and notifying the user with a dialog.

As discussed throughout the instant disclosure, the disclosed systems and methods may provide one or more advantages. For example, by determining that a detected user interaction represents a false positive input inference by a user interface, an embodiment of the disclosed systems and methods could use this information to take one or more remedial actions to refine the user interface’s recognition model to make fewer errors in the future. Additionally, the system could assist with error recovery if it could detect the errors soon enough after they occur. This capability may be particularly compelling for false positive errors. These false positive errors may be damaging to the user experience in part due to the attentional demands/costs to the user to detect and fix them when they occur. For example, if the system were to rapidly detect a false positive, it could increase the physical salience and size of an undo button or provide an “undo” confirmation dialogue.

Embodiments of the present disclosure may include or be implemented in conjunction with various types of artificial reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

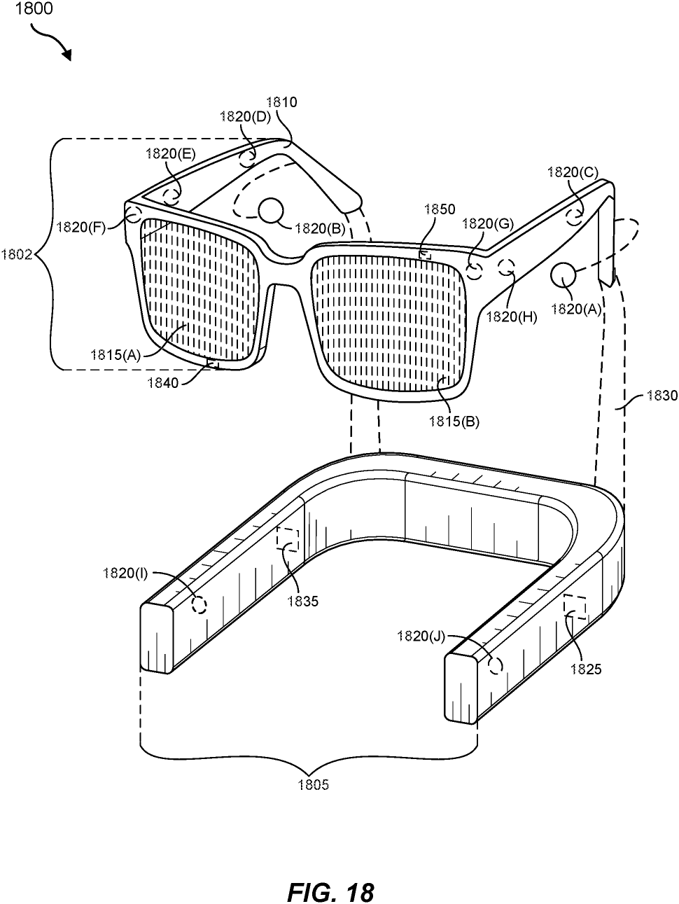

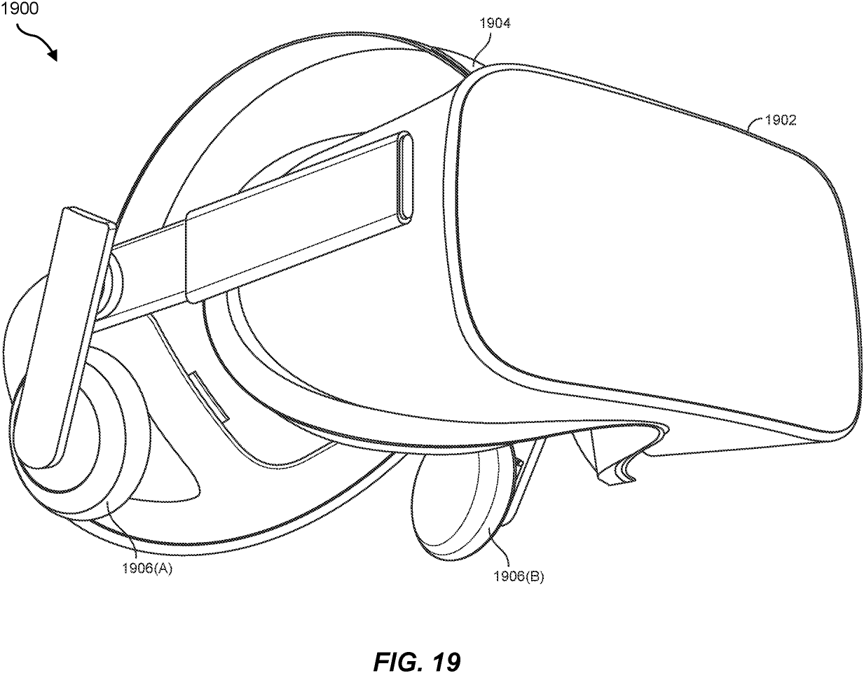

Artificial-reality systems may be implemented in a variety of different form factors and configurations. Some artificial reality systems may be designed to work without neareye displays (NEDs). Other artificial reality systems may include an NED that also provides visibility into the real world (such as, e.g., augmented-reality system 1800 in FIG. 18) or that visually immerses a user in an artificial reality (such as, e.g., virtual-reality system 1900 in FIG. 19). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 18, augmented-reality system 1800 may include an eyewear device 1802 with a frame 1810 configured to hold a left display device 1815(A) and a right display device 1815(B) in front of a user’s eyes. Display devices 1815(A) and 1815(B) may act together or independently to present an image or series of images to a user. While augmented-reality system 1800 includes two displays, embodiments of this disclosure may be implemented in augmented-reality systems with a single NED or more than two NEDs.

In some embodiments, augmented-reality system 1800 may include one or more sensors, such as sensor 1840. Sensor 1840 may generate measurement signals in response to motion of augmented-reality system 1800 and may be located on substantially any portion of frame 1810. Sensor 1840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1800 may or may not include sensor 1840 or may include more than one sensor. In embodiments in which sensor 1840 includes an IMU, the IMU may generate calibration data based on measurement signals from sensor 1840. Examples of sensor 1840 may include, without limitation, accelerometers, gyroscopes, magnetometers, other suitable types of sensors that detect motion, sensors used for error correction of the IMU, or some combination thereof.

In some examples, augmented-reality system 1800 may also include a microphone array with a plurality of acoustic transducers 1820(A)-1820(J), referred to collectively as acoustic transducers 1820. Acoustic transducers 1820 may represent transducers that detect air pressure variations induced by sound waves. Each acoustic transducer 1820 may be configured to detect sound and convert the detected sound into an electronic format (e.g., an analog or digital format). The microphone array in FIG. 18 may include, for example, ten acoustic transducers: 1820(A) and 1820(B), which may be designed to be placed inside a corresponding ear of the user, acoustic transducers 1820(C), 1820(D), 1820(E), 1820(F), 1820(G), and 1820(H), which may be positioned at various locations on frame 1810, and/or acoustic transducers 1820(l) and 1820(J), which may be positioned on a corresponding neckband 1805.

In some embodiments, one or more of acoustic transducers 1820(A)-(J) may be used as output transducers (e.g., speakers). For example, acoustic transducers 1820(A) and/or 1820(B) may be earbuds or any other suitable type of headphone or speaker.

The configuration of acoustic transducers 1820 of the microphone array may vary. While augmented-reality system 1800 is shown in FIG. 18 as having ten acoustic transducers 1820, the number of acoustic transducers 1820 may be greater or less than ten. In some embodiments, using higher numbers of acoustic transducers 1820 may increase the amount of audio information collected and/or the sensitivity and accuracy of the audio information. In contrast, using a lower number of acoustic transducers 1820 may decrease the computing power required by an associated controller 1850 to process the collected audio information. In addition, the position of each acoustic transducer 1820 of the microphone array may vary. For example, the position of an acoustic transducer 1820 may include a defined position on the user, a defined coordinate on frame 1810, an orientation associated with each acoustic transducer 1820, or some combination thereof.

Acoustic transducers 1820(A) and 1820(B) may be positioned on different parts of the user’s ear, such as behind the pinna, behind the tragus, and/or within the auricle or fossa. Or, there may be additional acoustic transducers 1820 on or surrounding the ear in addition to acoustic transducers 1820 inside the ear canal. Having an acoustic transducer 1820 positioned next to an ear canal of a user may enable the microphone array to collect information on how sounds arrive at the ear canal. By positioning at least two of acoustic transducers 1820 on either side of a user’s head (e.g., as binaural microphones), augmented-reality system 1800 may simulate binaural hearing and capture a 3D stereo sound field around about a user’s head. In some embodiments, acoustic transducers 1820(A) and 1820(B) may be connected to augmented-reality system 1800 via a wired connection 1830, and in other embodiments acoustic transducers 1820(A) and 1820(B) may be connected to augmented-reality system 1800 via a wireless connection (e.g., a BLUETOOTH connection). In still other embodiments, acoustic transducers 1820(A) and 1820(B) may not be used at all in conjunction with augmented-reality system 1800.

Acoustic transducers 1820 on frame 1810 may be positioned in a variety of different ways, including along the length of the temples, across the bridge, above or below display devices 1815(A) and 1815(B), or some combination thereof. Acoustic transducers 1820 may also be oriented such that the microphone array is able to detect sounds in a wide range of directions surrounding the user wearing the augmented-reality system 1800. In some embodiments, an optimization process may be performed during manufacturing of augmented-reality system 1800 to determine relative positioning of each acoustic transducer 1820 in the microphone array.

In some examples, augmented-reality system 1800 may include or be connected to an external device (e.g., a paired device), such as neckband 1805. Neckband 1805 generally represents any type or form of paired device. Thus, the following discussion of neckband 1805 may also apply to various other paired devices, such as charging cases, smart watches, smart phones, wrist bands, other wearable devices, hand-held controllers, tablet computers, laptop computers, other external computing devices, etc.

As shown, neckband 1805 may be coupled to eyewear device 1802 via one or more connectors. The connectors may be wired or wireless and may include electrical and/or non-electrical (e.g., structural) components. In some cases, eyewear device 1802 and neckband 1805 may operate independently without any wired or wireless connection between them. While FIG. 18 illustrates the components of eyewear device 1802 and neckband 1805 in example locations on eyewear device 1802 and neckband 1805, the components may be located elsewhere and/or distributed differently on eyewear device 1802 and/or neckband 1805. In some embodiments, the components of eyewear device 1802 and neckband 1805 may be located on one or more additional peripheral devices paired with eyewear device 1802, neckband 1805, or some combination thereof.

Pairing external devices, such as neckband 1805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1800 may be provided by a paired device or shared between a paired device and an eyewear device, thus reducing the weight, heat profile, and form factor of the eyewear device overall while still retaining desired functionality. For example, neckband 1805 may allow components that would otherwise be included on an eyewear device to be included in neckband 1805 since users may tolerate a heavier weight load on their shoulders than they would tolerate on their heads. Neckband 1805 may also have a larger surface area over which to diffuse and disperse heat to the ambient environment. Thus, neckband 1805 may allow for greater battery and computation capacity than might otherwise have been possible on a stand-alone eyewear device. Since weight carried in neckband 1805 may be less invasive to a user than weight carried in eyewear device 1802, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 1805 may be communicatively coupled with eyewear device 1802 and/or to other devices. These other devices may provide certain functions (e.g., tracking, localizing, depth mapping, processing, storage, etc.) to augmented-reality system 1800. In the embodiment of FIG. 18, neckband 1805 may include two acoustic transducers (e.g., 1820(l) and 1820(J)) that are part of the microphone array (or potentially form their own microphone subarray). Neckband 1805 may also include a controller 1825 and a power source 1835.

Acoustic transducers 1820(l) and 1820(J) of neckband 1805 may be configured to detect sound and convert the detected sound into an electronic format (analog or digital). In the embodiment of FIG. 18, acoustic transducers 1820(l) and 1820(J) may be positioned on neckband 1805, thereby increasing the distance between the neckband acoustic transducers 1820(l) and 1820(J) and other acoustic transducers 1820 positioned on eyewear device 1802. In some cases, increasing the distance between acoustic transducers 1820 of the microphone array may improve the accuracy of beamforming performed via the microphone array. For example, if a sound is detected by acoustic transducers 1820(C) and 1820(D) and the distance between acoustic transducers 1820(C) and 1820(D) is greater than, e.g., the distance between acoustic transducers 1820(D) and 1820(E), the determined source location of the detected sound may be more accurate than if the sound had been detected by acoustic transducers 1820(D) and 1820(E).

Controller 1825 of neckband 1805 may process information generated by the sensors on neckband 1805 and/or augmented-reality system 1800. For example, controller 1825 may process information from the microphone array that describes sounds detected by the microphone array. For each detected sound, controller 1825 may perform a direction-of-arrival (DOA) estimation to estimate a direction from which the detected sound arrived at the microphone array. As the microphone array detects sounds, controller 1825 may populate an audio data set with the information. In embodiments in which augmented-reality system 1800 includes an inertial measurement unit, controller 1825 may compute all inertial and spatial calculations from the IMU located on eyewear device 1802. A connector may convey information between augmented-reality system 1800 and neckband 1805 and between augmented-reality system 1800 and controller 1825. The information may be in the form of optical data, electrical data, wireless data, or any other transmittable data form. Moving the processing of information generated by augmented-reality system 1800 to neckband 1805 may reduce weight and heat in eyewear device 1802, making it more comfortable for the user.

Power source 1835 in neckband 1805 may provide power to eyewear device 1802 and/or to neckband 1805. Power source 1835 may include, without limitation, lithium-ion batteries, lithium-polymer batteries, primary lithium batteries, alkaline batteries, or any other form of power storage. In some cases, power source 1835 may be a wired power source. Including power source 1835 on neckband 1805 instead of on eyewear device 1802 may help better distribute the weight and heat generated by power source 1835.

As noted, some artificial reality systems may, instead of blending an artificial reality with actual reality, substantially replace one or more of a user’s sensory perceptions of the real world with a virtual experience. One example of this type of system is a head-worn display system, such as virtual-reality system 1900 in FIG. 19, that mostly or completely covers a user’s field of view. Virtual-reality system 1900 may include a front rigid body 1902 and a band 1904 shaped to fit around a user’s head. Virtual-reality system 1900 may also include output audio transducers 1906(A) and 1906(B). Furthermore, while not shown in FIG. 19, front rigid body 1902 may include one or more electronic elements, including one or more electronic displays, one or more inertial measurement units (IMUs), one or more tracking emitters or detectors, and/or any other suitable device or system for creating an artificial-reality experience.

Artificial reality systems may include a variety of types of visual feedback mechanisms. For example, display devices in augmented-reality system 1800 and/or virtual-reality system 1900 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial reality systems may include a single display screen for both eyes or may provide a display screen for each eye, which may allow for additional flexibility for varifocal adjustments or for correcting a user’s refractive error. Some of these artificial reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer’s eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented-reality system 1800 and/or virtual-reality system 1900 may include microLED projectors that project light (using, e.g., a waveguide) into display devices, such as clear combiner lenses that allow ambient light to pass through. The display devices may refract the projected light toward a user’s pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented-reality system 1800 and/or virtual-reality system 1900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, which may be incorporated into headwear, gloves, bodysuits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user’s real-world experience in a variety of contexts and environments. For instance, artificial reality systems may assist or extend a user’s perception, memory, or cognition within a particular environment. Some systems may enhance a user’s interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user’s artificial reality experience in one or more of these contexts and environments and/or in other contexts and environments.

In some embodiments, the systems described herein may also include an eye-tracking subsystem designed to identify and track various characteristics of a user’s eye(s), such as the user’s gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user’s eye(s).

FIG. 20 is an illustration of an exemplary system 2000 that incorporates an eye-tracking subsystem capable of tracking a user’s eye(s). As depicted in FIG. 20, system 2000 may include a light source 2002, an optical subsystem 2004, an eye-tracking subsystem 2006, and/or a control subsystem 2008. In some examples, light source 2002 may generate light for an image (e.g., to be presented to an eye 2001 of the viewer). Light source 2002 may represent any of a variety of suitable devices. For example, light source 2002 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray’s actual divergence.

In some embodiments, optical subsystem 2004 may receive the light generated by light source 2002 and generate, based on the received light, converging light 2020 that includes the image. In some examples, optical subsystem 2004 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 2020. Further, various mechanical couplings may serve to maintain the relative spacing and/or the orientation of the optical components in any suitable combination.

In one embodiment, eye-tracking subsystem 2006 may generate tracking information indicating a gaze angle of an eye 2001 of the viewer. In this embodiment, control subsystem 2008 may control aspects of optical subsystem 2004 (e.g., the angle of incidence of converging light 2020) based at least in part on this tracking information. Additionally, in some examples, control subsystem 2008 may store and utilize historical tracking information (e.g., a history of the tracking information over a given duration, such as the previous second or fraction thereof) to anticipate the gaze angle of eye 2001 (e.g., an angle between the visual axis and the anatomical axis of eye 2001). In some embodiments, eye-tracking subsystem 2006 may detect radiation emanating from some portion of eye 2001 (e.g., the cornea, the iris, the pupil, or the like) to determine the current gaze angle of eye 2001. In other examples, eye-tracking subsystem 2006 may employ a wavefront sensor to track the current location of the pupil.

Any number of techniques can be used to track eye 2001. Some techniques may involve illuminating eye 2001 with infrared light and measuring reflections with at least one optical sensor that is tuned to be sensitive to the infrared light. Information about how the infrared light is reflected from eye 2001 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 2006 may be digitized (i.e., converted to an electronic signal). Further, the sensor may transmit a digital representation of this electronic signal to one or more processors (for example, processors associated with a device including eye-tracking subsystem 2006). Eye-tracking subsystem 2006 may include any of a variety of sensors in a variety of different configurations. For example, eye-tracking subsystem 2006 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 2006 to track the movement of eye 2001. In another example, these processors may track the movements of eye 2001 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 2006 may be programmed to use an output of the sensor(s) to track movement of eye 2001. In some embodiments, eye-tracking subsystem 2006 may analyze the digital representation generated by the sensors to extract eye rotation information from changes in reflections. In one embodiment, eye-tracking subsystem 2006 may use corneal reflections or glints (also known as Purkinje images) and/or the center of the eye’s pupil 2022 as features to track over time.

In some embodiments, eye-tracking subsystem 2006 may use the center of the eye’s pupil 2022 and infrared or near-infrared, non-collimated light to create corneal reflections. In these embodiments, eye-tracking subsystem 2006 may use the vector between the center of the eye’s pupil 2022 and the corneal reflections to compute the gaze direction of eye 2001. In some embodiments, the disclosed systems may perform a calibration procedure for an individual (using, e.g., supervised or unsupervised techniques) before tracking the user’s eyes. For example, the calibration procedure may include directing users to look at one or more points displayed on a display while the eye-tracking system records the values that correspond to each gaze position associated with each point.

In some embodiments, eye-tracking subsystem 2006 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 2001 may act as a retroreflector as the light reflects off the retina, thereby creating a bright pupil effect similar to a red-eye effect in photography. If the illumination source is offset from the optical path, then the eye’s pupil 2022 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 2008 may control light source 2002 and/or optical subsystem 2004 to reduce optical aberrations (e.g., chromatic aberrations and/or monochromatic aberrations) of the image that may be caused by or influenced by eye 2001. In some examples, as mentioned above, control subsystem 2008 may use the tracking information from eye-tracking subsystem 2006 to perform such control. For example, in controlling light source 2002, control subsystem 2008 may alter the light generated by light source 2002 (e.g., by way of image rendering) to modify (e.g., pre-distort) the image so that the aberration of the image caused by eye 2001 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user’s eye may necessitate modification of a corresponding eye-tracking algorithm. For example, eye-tracking algorithms may need to be modified based at least in part on the differing color contrast between a brown eye and, for example, a blue eye.

FIG. 21 is a more detailed illustration of various aspects of the eye-tracking subsystem illustrated in FIG. 20. As shown in this figure, an eye-tracking subsystem 2100 may include at least one source 2104 and at least one sensor 2106. Source 2104 generally represents any type or form of element capable of emitting radiation. In one example, source 2104 may generate visible, infrared, and/or near-infrared radiation. In some examples, source 2104 may radiate non-collimated infrared and/or near-infrared portions of the electromagnetic spectrum towards an eye 2102 of a user. Source 2104 may utilize a variety of sampling rates and speeds. For example, the disclosed systems may use sources with higher sampling rates in order to capture fixational eye movements of a user’s eye 2102 and/or to correctly measure saccade dynamics of the user’s eye 2102. As noted above, any type or form of eye-tracking technique may be used to track the user’s eye 2102, including optical-based eye-tracking techniques, ultrasound-based eye-tracking techniques, etc.

Sensor 2106 generally represents any type or form of element capable of detecting radiation, such as radiation reflected off the user’s eye 2102. Examples of sensor 2106 include, without limitation, a charge coupled device (CCD), a photodiode array, a complementary metal-oxide-semiconductor (CMOS) based sensor device, and/or the like. In one example, sensor 2106 may represent a sensor having predetermined parameters, including, but not limited to, a dynamic resolution range, linearity, and/or other characteristic selected and/or designed specifically for eye tracking.

As detailed above, eye-tracking subsystem 2100 may generate one or more glints. As detailed above, a glint 2103 may represent reflections of radiation (e.g., infrared radiation from an infrared source, such as source 2104) from the structure of the user’s eye. In various embodiments, glint 2103 and/or the user’s pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 21 shows an example image 2105 captured by an eye-tracking subsystem, such as eye-tracking subsystem 2100. In this example, image 2105 may include both the user’s pupil 2108 and a glint 2110 near the same. In some examples, pupil 2108 and/or glint 2110 may be identified using an artificial-intelligence-based algorithm, such as a computer-vision-based algorithm. In one embodiment, image 2105 may represent a single frame in a series of frames that may be analyzed continuously in order to track the eye 2102 of the user. Further, pupil 2108 and/or glint 2110 may be tracked over a period of time to determine a user’s gaze.

In one example, eye-tracking subsystem 2100 may be configured to identify and measure the inter-pupillary distance (IPD) of a user. In some embodiments, eye-tracking subsystem 2100 may measure and/or calculate the IPD of the user while the user is wearing the artificial reality system. In these embodiments, eye-tracking subsystem 2100 may detect the positions of a user’s eyes and may use this information to calculate the user’s IPD.

As noted, the eye-tracking systems or subsystems disclosed herein may track a user’s eye position and/or eye movement in a variety of ways. In one example, one or more light sources and/or optical sensors may capture an image of the user’s eyes. The eye-tracking subsystem may then use the captured information to determine the user’s inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user’s pupil and a display may change as the user’s eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user’s eyes and applying a distortion correction corresponding to the 3D position of each of the user’s eyes at a given point in time. Thus, knowing the 3D position of each of a user’s eyes may allow for the mitigation of distortion caused by changes in the distance between the pupil of the eye and the display by applying a distortion correction for each 3D eye position. Furthermore, as noted above, knowing the position of each of the user’s eyes may also enable the eye-tracking subsystem to make automated adjustments for a user’s IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user’s gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user’s eyes are verged is where the user is looking and is also typically the location where the user’s eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user’s eyes are directed. Thus, the vergence distance may allow for the determination of a location where the user’s eyes should be focused and a depth from the user’s eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user’s vergence depth. When the user is focused on something at a distance, the user’s pupils may be slightly farther apart than when the user is focused on something close. The eye-tracking subsystem may obtain information about the user’s vergence or focus depth and may adjust the display subsystem to be closer together when the user’s eyes focus or verge on something close and to be farther apart when the user’s eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user’s eye movement, such that if a user is looking up, the computer-generated images may be moved upward on the screen. Similarly, if the user is looking to the side or down, the computer-generated images may be moved to the side or downward on the screen. If the user’s eyes are closed, the computer-generated images may be paused or removed from the display and resumed once the user’s eyes are back open.

The above-described eye-tracking subsystems can be incorporated into one or more of the various artificial reality systems described herein in a variety of ways. For example, one or more of the various components of system 2000 and/or eye-tracking subsystem 2100 may be incorporated into augmented-reality system 1800 in FIG. 18 and/or virtual-reality system 1900 in FIG. 19 to enable these systems to perform various eye-tracking tasks (including one or more of the eye-tracking operations described herein).

The following example embodiments are also included in this disclosure.

Example 1: A computer-implemented method including (1) tracking a gaze of a user as the user interacts with a user interface, (2) determining, based on tracking of the gaze of the user, that a detected user interaction with the user interface represents a false positive input inference by the user interface, and (3) executing at least one remedial action based on determining that the detected user interaction represents the false positive input inference by the user interface.

Example 2: The computer-implemented method of example 1, wherein tracking the gaze of the user includes extracting at least one gaze feature from the gaze of the user as the user interacts with the user interface.

Example 3: The computer-implemented method of example 2, wherein the at least one gaze feature includes at least one of (1) a fixation duration, (2) an angular displacement between an initial fixation centroid and a subsequent fixation centroid, (3) an angular displacement between an initial saccade centroid and a subsequent saccade centroid, (4) an angular displacement between an initial saccade landing point and a subsequent saccade landing point, (5) an amplitude of a saccade, (6) a duration of a saccade, (7) a fixation probability, (8) a saccade probability, (9) a gaze velocity, or (10) a gaze dispersion.

Example 4: The computer-implemented method of any of examples 1-3, wherein determining, based on tracking of the gaze of the user, that the detected user interaction with the user interface represents the false positive input inference by the user interface includes (1) training, using gaze features of the user, a machine learning model to discriminate between true positive events and false positive events, and (2) analyzing the tracked gaze of the user using the trained machine learning model.

Example 5: The computer-implemented method of any of examples 1-4, wherein determining, based on tracking of the gaze of the user, that the detected user interaction with the user interface represents the false positive input inference by the user interface includes (1) training, using gaze features of a group of users, a machine learning model to discriminate between true positive events and false positive events, and (2) analyzing the tracked gaze of the user using the trained machine learning model.

Example 6: The computer-implemented method of any of examples 1-5, wherein (1) executing the at least one remedial action includes receiving, via the user interface, user input associated with the false positive input inference, and (2) the method further includes determining, based on additional tracking of the gaze of the user and the user input associated with the false positive input inference, that an additional detected user interaction with the user interface represents an additional false positive input inference by the user interface.

Example 7: The computer-implemented method of any of examples 1-6, wherein executing the at least one remedial action includes (1) determining that the detected user interaction with the user interface caused a change in an application state of an application associated with the user interface, and (2) automatically undoing the change in the application state.

Example 8: The computer-implemented method of any of examples 1-7, wherein executing the at least one remedial action includes presenting a notification within the user interface that indicates that a false positive input inference has occurred.

Example 9: The computer-implemented method of example 8, wherein the notification further indicates that the detected user interaction caused a change in an application state of an application associated with the user interface.

Example 10: The computer-implemented method of any of examples 8-9, wherein the notification further includes a confirmation control that enables the user to confirm the detected user interaction.

Example 11: The computer-implemented method of any of examples 8-10, wherein (1) the notification includes an undo control, and (2) the method further includes (A) receiving, via the undo control of the user interface, an instruction to undo a command executed as a result of the detected user interaction, and (B) undoing, in response to receiving the instruction to undo the command executed as a result of the detected user interaction, the command executed as a result of the detected user interaction.

Example 12: A system including (1) a tracking module, stored in memory, that tracks a gaze of a user as the user interacts with a user interface, (2) a determining module, stored in memory, that determines, based on tracking of the gaze of the user, that a detected user interaction with the user interface represents a false positive input inference by the user interface, (3) an executing module, stored in memory, that executes at least one remedial action based on determining that the detected user interaction represents the false positive input inference by the user interface, and (4) at least one physical processor that executes the tracking module, the determining module, and the executing module.

Example 13: The system of example 12, wherein the tracking module tracks the gaze of the user by extracting at least one gaze feature from the gaze of the user as the user interacts with the user interface.

Example 14: The system of example 13, wherein the at least one gaze feature includes at least one of (1) a fixation duration, (2) an angular displacement between an initial fixation centroid and a subsequent fixation centroid, (3) an angular displacement between an initial saccade centroid and a subsequent saccade centroid, (4) an angular displacement between an initial saccade landing point and a subsequent saccade landing point, (5) an amplitude of a saccade, (6) a duration of a saccade, (7) a fixation probability, (8) a saccade probability, (9) a gaze velocity, or (10) a gaze dispersion.

Example 15: The system of any of examples 12-14, wherein the determining module determines, based on tracking of the gaze of the user, that the detected user interaction with the user interface represents the false positive input inference by the user interface by (1) training, using gaze features of the user, a machine learning model to discriminate between true positive events and false positive events, and (2) analyzing the tracked gaze of the user using the trained machine learning model.

Example 16: The system of any of examples 12-15, wherein the determining module determines, based on tracking of the gaze of the user, that the detected user interaction with the user interface represents the false positive input inference by the user interface by (1) training, using gaze features of a group of users, a machine learning model to discriminate between true positive events and false positive events, and (2) analyzing the tracked gaze of the user using the trained machine learning model.

Example 17: The system of any of examples 12-16, wherein (1) the executing module executes the at least one remedial action by receiving, via the user interface, user input associated with the false positive input inference, and (2) the determining module further determines, based on additional tracking of the gaze of the user and the user input associated with the false positive input inference, that an additional detected user interaction with the user interface represents an additional false positive input inference by the user interface.

Example 18: The system of any of examples 12-17, wherein the executing module executes the at least one remedial action by (1) determining that the detected user interaction with the user interface caused a change in an application state of an application associated with the user interface, and (2) automatically undoing the change in the application state.

Example 19: A non-transitory computer-readable medium including computer-readable instructions that, when executed by at least one processor of a computing system, cause the computing system to (1) track a gaze of a user as the user interacts with a user interface, (2) determine, based on tracking of the gaze of the user, that a detected user interaction with the user interface represents a false positive input inference by the user interface, and (3) execute at least one remedial action based on determining that the detected user interaction represents the false positive input inference by the user interface.

Example 20: The non-transitory computer-readable medium of example 19, wherein the computer-readable instructions, when executed by the at least one processor of the computing system, cause the computing system to track the gaze of the user by extracting at least one gaze feature from the gaze of the user as the user interacts with the user interface.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive eye tracking to be transformed, transform the eye tracking data, output a result of the transformation to determine whether a user interaction with a user interface represents a false positive input inference by the user interface, use the result of the transformation to execute a remedial action, and store the result of the transformation to improve a model of user interaction. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmissiontype media, such as carrier waves, and non-transitory-type media, such as magnetic-storage media (e.g., hard disk drives, tape drives, and floppy disks), optical-storage media (e.g., Compact Discs (CDs), Digital Video Discs (DVDs), and BLU-RAY discs), electronic-storage media (e.g., solidstate drives and flash media), and other distribution systems.

As described above, embodiments of the instant disclosure may include or be implemented in conjunction with an artificial reality system. Artificial reality is a form of reality that has been adjusted in some manner before presentation to a user, which may include, e.g., a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
tracking a gaze of a user as the user interacts with a user interface;
determining, based on tracking of the gaze of the user, that a detected user interaction with the user interface represents a false positive input inference by the user interface; and
executing at least one remedial action based on determining that the detected user interaction represents the false positive input inference by the user interface.

2. The computer-implemented method of claim 1, wherein tracking the gaze of the user comprises extracting at least one gaze feature from the gaze of the user as the user interacts with the user interface.

3. The computer-implemented method of claim 2, wherein the at least one gaze feature comprises at least one of:
a fixation duration;
an angular displacement between an initial fixation centroid and a subsequent fixation centroid;
an angular displacement between an initial saccade centroid and a subsequent saccade centroid;
an angular displacement between an initial saccade landing point and a subsequent saccade landing point;
an amplitude of a saccade;
a duration of a saccade;
a fixation probability;
a saccade probability;
a gaze velocity; or
a gaze dispersion.

4. The computer-implemented method of claim 1, wherein determining, based on tracking of the gaze of the user, that the detected user interaction with the user interface represents the false positive input inference by the user interface comprises:
training, using gaze features of the user, a machine learning model to discriminate between true positive events and false positive events; and
analyzing the tracked gaze of the user using the trained machine learning model.

5. The computer-implemented method of claim 1, wherein determining, based on tracking of the gaze of the user, that the detected user interaction with the user interface represents the false positive input inference by the user interface comprises:
training, using gaze features of a group of users, a machine learning model to discriminate between true positive events and false positive events; and
analyzing the tracked gaze of the user using the trained machine learning model.

6. The computer-implemented method of claim 1, wherein:
executing the at least one remedial action comprises receiving, via the user interface, user input associated with the false positive input inference; and
the method further comprises determining, based on additional tracking of the gaze of the user and the user input associated with the false positive input inference, that an additional detected user interaction with the user interface represents an additional false positive input inference by the user interface.

7. The computer-implemented method of claim 1, wherein executing the at least one remedial action comprises:
determining that the detected user interaction with the user interface caused a change in an application state of an application associated with the user interface; and
automatically undoing the change in the application state.

8. The computer-implemented method of claim 1, wherein executing the at least one remedial action comprises presenting a notification within the user interface that indicates that a false positive input inference has occurred.

9. The computer-implemented method of claim 8, wherein the notification further indicates that the detected user interaction caused a change in an application state of an application associated with the user interface.

10. The computer-implemented method of claim 8, wherein the notification further comprises a confirmation control that enables the user to confirm the detected user interaction.

11. The computer-implemented method of claim 8, wherein:
the notification comprises an undo control; and
the method further comprises:
receiving, via the undo control of the user interface, an instruction to undo a command executed as a result of the detected user interaction; and
undoing, in response to receiving the instruction to undo the command executed as a result of the detected user interaction, the command executed as a result of the detected user interaction.

12. A system comprising:
a tracking module, stored in memory, that tracks a gaze of a user as the user interacts with a user interface;
a determining module, stored in memory, that determines, based on tracking of the gaze of the user, that a detected user interaction with the user interface represents a false positive input inference by the user interface;
an executing module, stored in memory, that executes at least one remedial action based on determining that the detected user interaction represents the false positive input inference by the user interface; and
at least one physical processor that executes the tracking module, the determining module, and the executing module.

13. The system of claim 12, wherein the tracking module tracks the gaze of the user by extracting at least one gaze feature from the gaze of the user as the user interacts with the user interface.

14. The system of claim 13, wherein the at least one gaze feature comprises at least one of:
a fixation duration;
an angular displacement between an initial fixation centroid and a subsequent fixation centroid;
an angular displacement between an initial saccade centroid and a subsequent saccade centroid;
an angular displacement between an initial saccade landing point and a subsequent saccade landing point;
an amplitude of a saccade;
a duration of a saccade;
a fixation probability;
a saccade probability;
a gaze velocity; or
a gaze dispersion.

15. The system of claim 12, wherein the determining module determines, based on tracking of the gaze of the user, that the detected user interaction with the user interface represents the false positive input inference by the user interface by:
training, using gaze features of the user, a machine learning model to discriminate between true positive events and false positive events; and
analyzing the tracked gaze of the user using the trained machine learning model.

16. The system of claim 12, wherein the determining module determines, based on tracking of the gaze of the user, that the detected user interaction with the user interface represents the false positive input inference by the user interface by:
training, using gaze features of a group of users, a machine learning model to discriminate between true positive events and false positive events; and
analyzing the tracked gaze of the user using the trained machine learning model.

17. The system of claim 12, wherein:
the executing module executes the at least one remedial action by receiving, via the user interface, user input associated with the false positive input inference; and
the determining module further determines, based on additional tracking of the gaze of the user and the user input associated with the false positive input inference, that an additional detected user interaction with the user interface represents an additional false positive input inference by the user interface.

18. The system of claim 12, wherein the executing module executes the at least one remedial action by:
determining that the detected user interaction with the user interface caused a change in an application state of an application associated with the user interface; and
automatically undoing the change in the application state.

19. A non-transitory computer-readable medium comprising computer-readable instructions that, when executed by at least one processor of a computing system, cause the computing system to:
track a gaze of a user as the user interacts with a user interface;
determine, based on tracking of the gaze of the user, that a detected user interaction with the user interface represents a false positive input inference by the user interface; and
execute at least one remedial action based on determining that the detected user interaction represents the false positive input inference by the user interface.

20. The non-transitory computer-readable medium of claim 19, wherein the computer-readable instructions, when executed by the at least one processor of the computing system, cause the computing system to track the gaze of the user by extracting at least one gaze feature from the gaze of the user as the user interacts with the user interface.
